(19) United States
(12) Patent Application Publication
(10) Pub. No.: US 2016/0280425 A1
(43) Pub. Date: Sep. 29, 2016

(54) BAGS AND METHODS OF MAKING BAGS

(71) Applicant: Automated Packaging Systems, Inc., Streetsboro, OH (US)

(72) Inventors: Rick Steven Wehrmann, Hudson, OH (US); Bernard Lerner, Aurora, OH (US)

(21) Appl. No.: 15/080,104

(22) Filed: Mar. 24, 2016

Related U.S. Application Data
(60) Provisional application No. 62/137,267, filed on Mar. 24, 2015.

(51) Int. Cl. B65D 33/00; B31B 19/96; B31B 23/00; B31B 19/60

(52) U.S. Cl. CPC B65D 33/002; B65D 33/007; B31B 19/60; B31B 19/96; B31B 23/00

(57) ABSTRACT

An exemplary web of preformed bags includes first and second layers, first and second side edges that hermetically join the first and second layers, a plurality of transverse seals extending between the first and second side edges, a plurality of first lines of weakness in the first layer, and a plurality of second lines of weakness in the second layer. The first lines of weakness are weaker than the second lines of weakness. The preformed bags are defined by the first and second side edges, the first and second lines of weakness, and the transverse seals.

### RELATED APPLICATIONS

This application claims priority to and the benefit of U.S. Provisional Patent Application No. 62/137,267, filed on Mar. 24, 2015, which is incorporated herein by reference in its entirety.

### TECHNICAL FIELD

The present application relates generally to packaging and in particular to preformed bags, a web of preformed bags, and methods of forming and using a web of preformed bags.

### BACKGROUND OF THE INVENTION

U.S. Pat. No. 3,254,828, issued Jun. 7, 1966, to Hershey Lerner under the title Flexible Container Strips is directed to so called bags on a roll (here the AutoBag patent). U.S. Pat. No. 3,254,828 is incorporated herein by reference in its entirety. This patent discloses a web of bags interconnected by lines of weakness, preferably in the form of perforations, with each of the bags being open on one face. In use the bags are sequentially fed to a loading station. When at the loading station, each bag is blown open, a product is inserted and, if desired, the bag is sealed to form a package. The formed package is separated from the web.

These container strips in the form of chains of pre-opened bags are supplied either on a roll as taught in the AutoBag patent or festooned in a carton in the manner taught in U.S. Pat. No. 4,201,029, issued May 6, 1980, to Bernard Lerner et al. under the title Method and Apparatus for Packaging, (here the Wig-Wag patent). Such container strips have been sold by Automated Packaging Systems, Inc. of Streetsboro, Ohio, the assignee of the present case, under the trademark AutoBag and have enjoyed great commercial success.

Both AutoBag and competitive products have usually been made by feeding two layers or a tube of plastic material through a converting machine. Such a machine forms transverse seals to delineate the bottoms of the bags and transverse lines of weakness by perforating both layers of the tube to delineate contiguous ends of adjacent bags. After the perforations are formed, a “zinging” operation is performed on each bag to open the front of the bag while leaving the perforations of the back layer intact.

### SUMMARY

Exemplary embodiments of webs of preformed bags and methods of forming the same are disclosed herein.

An exemplary web of preformed bags includes first and second layers, first and second side edges that hermetically join the first and second layers, a plurality of transverse seals extending between the first and second side edges, a plurality of first lines of weakness in the first layer, and a plurality of second lines of weakness in the second layer. The first lines of weakness are weaker than the second lines of weakness. The preformed bags are defined by the first and second side edges, the first and second lines of weakness, and the transverse seals.

Another exemplary embodiment of the present disclosure relates to a method for forming packages from a web of preformed bags. The method includes providing a web of preformed bags and breaking a first line of weakness without completely breaking a second line of weakness to open a bag of the web of preformed bags. The web of preformed bags includes first and second elongated layers, first and second side edges that hermetically join the first and second layers, a plurality of transverse seals extending between the first and second side edges, a plurality of first lines of weakness in the first layer, and a plurality of second lines of weakness in the second layer. The first lines of weakness are weaker than the second lines of weakness.

### BRIEF DESCRIPTION OF THE DRAWINGS

These and other features and advantages of the present invention will become better understood with regard to the following description and accompanying drawings in which:

FIG. 1A is a fragmentary plan view of a section of an exemplary embodiment of a chain of bags interconnected by a relatively more strong line of separation in a top or outer ply a relatively less strong line of separation in a bottom or inner ply;

FIG. 1B is a fragmentary plan view of a section of an exemplary embodiment of a chain of bags interconnected by a relatively more strong line of separation in a first ply a relatively less strong line of separation in a second ply;

FIG. 1C is a fragmentary plan view of a section of an exemplary embodiment of a chain bags interconnected by a relatively more strong line of separation in a first ply a relatively less strong line of separation in a second ply;

FIG. 2 is a side elevational, schematic view of an exemplary embodiment of a machine for making the bags of FIGS. 1A-1C;

FIG. 3 is a schematic plan view of the machine of FIG. 3;

FIG. 4 is a perspective view of an exemplary embodiment of a machine for making the bags of FIGS. 1A-1C;

FIG. 5 is a perspective view of an exemplary embodiment of a machine for making the bags of FIGS. 1A-1C;

FIG. 6 is a view of an exemplary embodiment of a package;

FIG. 7 is a view of the package taken along lines 7-7 in FIG. 6;

FIG. 8 is a flow chart that illustrates a process of opening bags, loading bags with a product, sealing the bags, and separating the bags from a web of bags;

FIG. 9 is a schematic illustration of an exemplary apparatus for making packages from an elongated web of preformed interconnected bags;

FIG. 10 is a view of the apparatus taken along lines 10-10 in FIG. 9;

FIG. 11 is a schematic illustration of the apparatus with the bag in an open condition for loading with a product;

FIG. 12 is a view of the apparatus taken along lines 12-12 in FIG. 11;

FIG. 13 is a schematic illustration of the apparatus with an engagement member positioned to reduce a volume of air in the loaded bag;

FIG. 14 is a view of the apparatus taken along lines 14-14 in FIG. 13;

FIG. 15 is a schematic illustration of the apparatus with the bag being sealed to enclose the product in the package;

FIG. 16 is a view of the apparatus taken along lines 16-16 in FIG. 15;

FIG. 17 is a schematic illustration of the apparatus pulling the web away from the loaded bag to separate the loaded bag from the web by reverse indexing rollers;

FIG. 18 is a view of the apparatus taken along lines 18-18 in FIG. 17;

FIG. 19 is a schematic illustration of the apparatus releasing an exemplary package;

FIG. 20 is a view of the apparatus taken along lines 20-20 in FIG. 19;

FIG. 21 is a schematic illustration of the apparatus with a bag positioned for pre-opening by engagement with an engagement member;

FIG. 21A is a schematic illustration of another exemplary embodiment of an apparatus for making packages from an elongated web of preformed interconnected bags with a bag positioned for pre-opening by engagement with a sealing device;

FIG. 21B is a schematic illustration of another exemplary embodiment of an apparatus for making packages from an elongated web of preformed interconnected bags with a bag positioned for opening with a sealing device;

FIG. 22 is a view of the apparatus taken along lines 22-22 in FIG. 21;

FIG. 23 is a schematic illustration of the apparatus with a bag being pre-opened by breaking a relatively less strong line of connection in a face ply upon engagement with an engagement member and reverse indexing of a drive;

FIG. 23A is a schematic illustration of the apparatus with a bag being pre-opened by breaking a relatively less strong line of connection in a face ply upon engagement with a sealing device and reverse indexing of a drive;

FIG. 23B is a schematic illustration of the apparatus with a bag being opened by breaking a relatively less strong line of connection in a face ply by pulling the face ply with a sealing device;

FIG. 24 is a view of the apparatus taken along lines 24-24 in FIG. 23;

FIG. 25 is a schematic illustration of the apparatus with the bag being blown open by a source of air;

FIG. 25A is a schematic illustration of the apparatus illustrated by FIG. 24A with the bag being blown open by a source of air;

FIG. 25B is a schematic illustration of the apparatus illustrated by FIG. 24B with the bag being blown open by a source of air;

FIG. 26 is a view of the apparatus taken along lines 26-26 in FIG. 25;

FIG. 27 is a schematic illustration of the apparatus with the bag in the open condition for loading with a product;

FIG. 28 is a view of the apparatus taken along lines 28-28 in FIG. 27;

FIG. 29 illustrates an engagement member with an optional device that helps the engagement member break the relatively less strong line of connection in the face ply to pre-open the bags;

FIG. 30 illustrates an engagement member with an optional device that helps the engagement member break the relatively less strong line of connection in the face ply to pre-open the bags;

FIG. 31 illustrates an engagement member with an optional device that helps the engagement member break the relatively less strong line of connection in the face ply to pre-open the bags;

FIG. 32 illustrates an engagement member with an optional device that helps the engagement member break the relatively less strong line of connection in the face ply to pre-open the bags;

FIGS. 33A and 33B illustrate a bag opening device that pulls on the web to break the relatively less strong line of connection in the face ply to open the bags;

FIGS. 34A-34C are schematic illustrations of an exemplary apparatus for making packages from an elongated web of preformed interconnected bags;

FIGS. 35A and 35B are schematic illustrations of an exemplary apparatus for making packages from an elongated web of preformed interconnected bags; and

FIGS. 36A-36C is an illustration of a process for making an elongated web of preformed interconnected bags, rolling the elongated web of preformed bags onto a roll, and preopening the bags while on the roll to inhibit air from entering the open bag.

### DETAILED DESCRIPTION

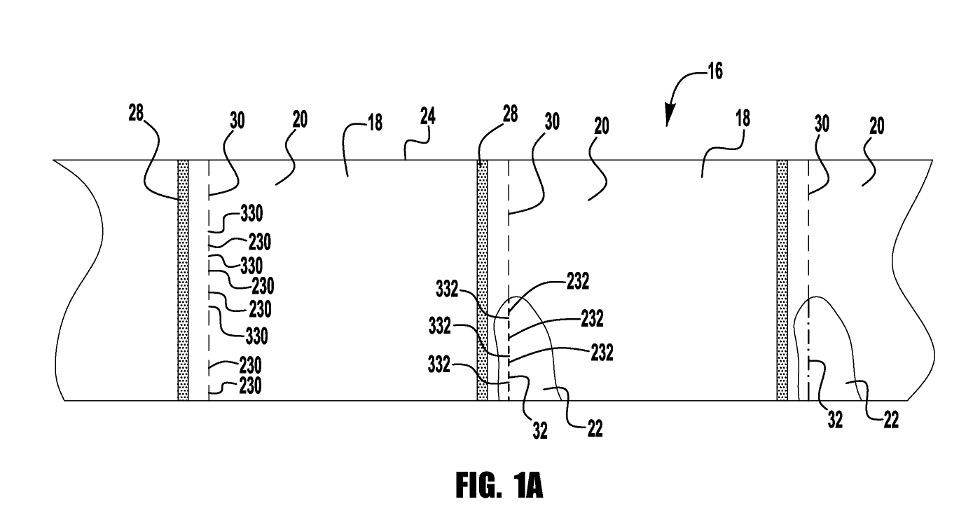

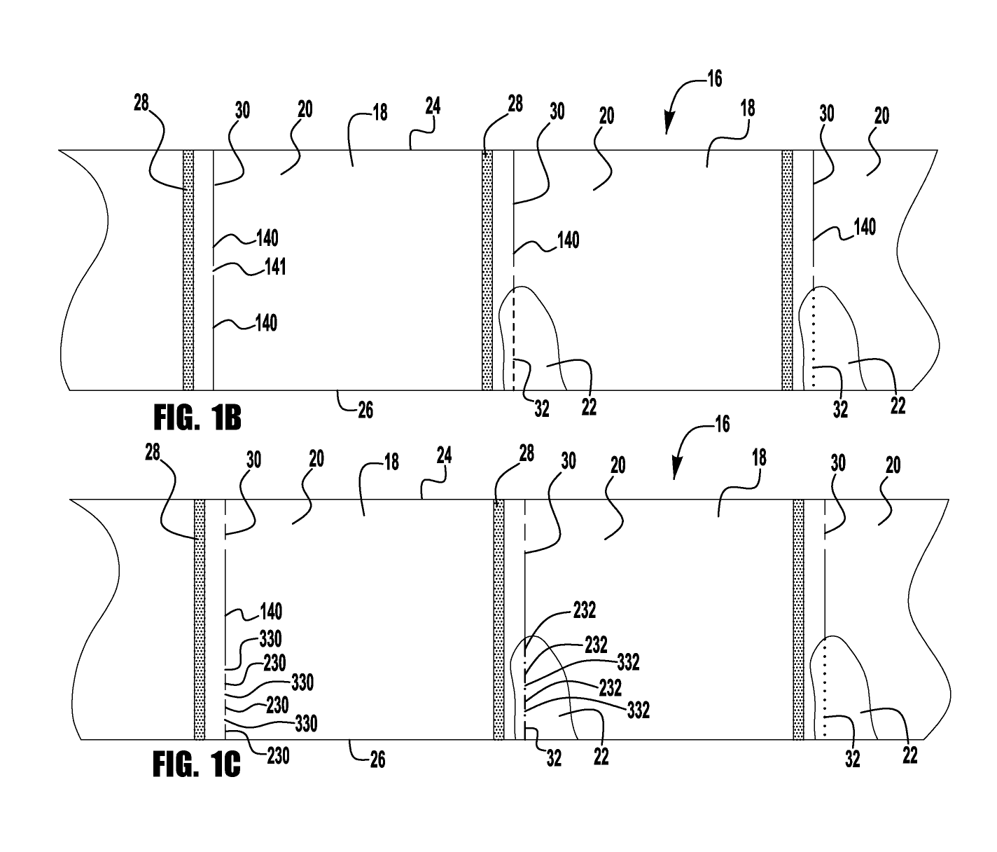

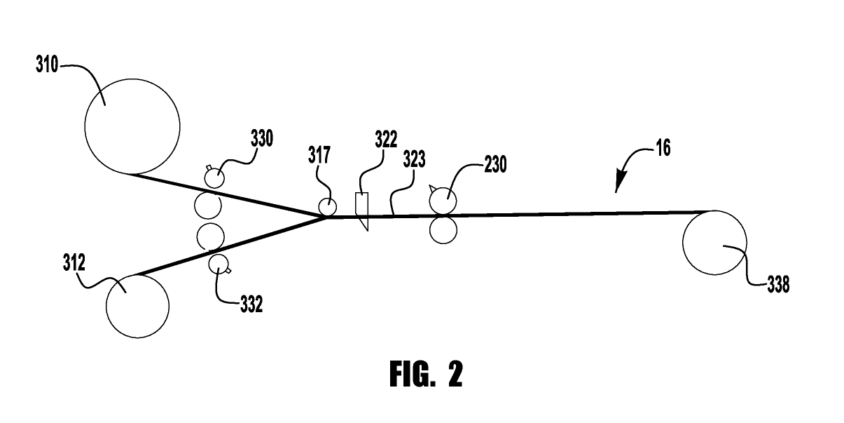

The present application relates to an elongated web 16 (FIGS. 1A and 2A) of preformed interconnected bags 18. In an exemplary embodiment, the web 16 has weaker line of separation 30 defined in a first ply 20 and a stronger line of separation 32 in a second ply 22. The weaker line of separation 30 is weaker than the stronger line of separation 32. For example, the tensile force required to break or tear the first ply 20 apart at the weaker line of separation 30 is less than the tensile force required to break or tear the second ply 22 apart at the stronger line of separation 32.

In one exemplary embodiment, a tensile force can be applied to the web 16 (i.e. to both plies) that breaks or tears the first ply 20 apart at the weaker line of separation 30 and leaves the stronger line of separation 32 intact.

The weaker line of separation 30 allows the openings 130 of the bags 18 to be formed at a packaging machine 10, instead of during production of the web 16 of bags 18. That is, the openings 130 can be formed by breaking or tearing the first ply 20 along the weaker line of separation 30 with the packaging machine 10.

The webs 16 of preformed interconnected bags 18 can take a wide variety of different forms. In the exemplary embodiments illustrated by FIGS. 1A-1C, each preformed bag 18 is defined by first and second plies 20, 22 of the web 16. First and second side edges 24, 26 of the web hermetically join the first and second plies. Preformed seals 28 extend between the first and second side edges 24, 26. The weaker line of separation 30 extends between the first and second side edges 24, 26. The stronger line of separation 32, such as a line of perforations in the second ply 22 extends between the first and second side edges 24, 26. In one exemplary embodiment, the weaker line of separation 30 is superposed over the stronger line of perforations 32. In another exemplary embodiment, the weaker line of perforations and the stronger line of perforations 32 are offset.

The web 16 of preformed bags 18 illustrated by FIGS. 1A and 1B is one example of the wide variety of different webs that may be used. Examples of acceptable webs of preformed interconnected bags that can be modified to include a weaker line of separation 30 in the first ply 20 and the stronger line of separation in the second ply 22 include, but are not limited to, the webs disclosed in U.S. Pat. No. 3,254,828 to H. Lerner and U.S. Pat. No. 5,957,824 to B. Lerner et al., which are incorporated herein by reference in their entirety.

The weaker line of separation 30 may take a wide variety of different forms. In the example illustrated by FIG. 1A, the perforations 230 of the weaker line of separation 30 are longer than the perforations 232 of the stronger line of separation 32 and the length of the gaps 330 between the perforations 230 of the weaker line of separation 30 are the same or about the same as the length of the gaps 332 between the perforations 232 of the stronger line of separation 32. As such, the first ply 20 includes less material along the weaker line of separation 30 than the second ply 22 includes along the stronger line of separation 32. As a result, the weaker line of separation 30 is weaker than the stronger line of separation 32.

In the example illustrated by FIG. 1B, the weaker line of separation 30 comprises elongated cuts 140 that are connected by a solid section or tick 141 of the ply 20. Two long cuts 140 that extend inward from the side edges 24, 26 to the solid section or tick 141 are illustrated in the FIG. 1B. However, any number of cuts 140 and ticks 141 can be included. The first ply 20 includes only the tick 141 or ticks along the weaker line of separation 30. As a result, the weaker line of separation 30 is weaker than the stronger line of separation 32.

In the example illustrated by FIG. 1C, the weaker line of separation comprises perforations 230 and an elongated cut 140. The perforations 230 of the weaker line of separation 30 are longer than the perforations 232 of the stronger line of separation 32 and the length of the gaps 330 between the perforations 230 of the weaker line of separation 30 are the same or about the same as the length of the gaps 332 between the perforations 232 of the stronger line of separation 32. The perforations extend inward from the side edges 24, 26 to the elongated cut 140.

FIGS. 1A-1C provide just a few of the many possible configurations of the weaker line of separation 30. Any configuration that makes the line of separation 30 weaker than the line of separation 32 can be used. For example, the weaker line of separation 30 and the stronger line of separation 32 perforations may have the same configuration, but the first ply 20 is made from a weaker material than the second ply 22. As a result, the first ply 20 tears or separates along the weaker line of separation 30 more easily than the second ply 22 tears or separates along the stronger line of separation 32.

The web 16 may be formed of any suitable material. Examples of suitable materials include, but are not limited to, plastic materials, polyethylene, cellophane, vinyl films, pliofilms, cellulose acetate film, polystyrene, polypropylene, and any heat sealable material.

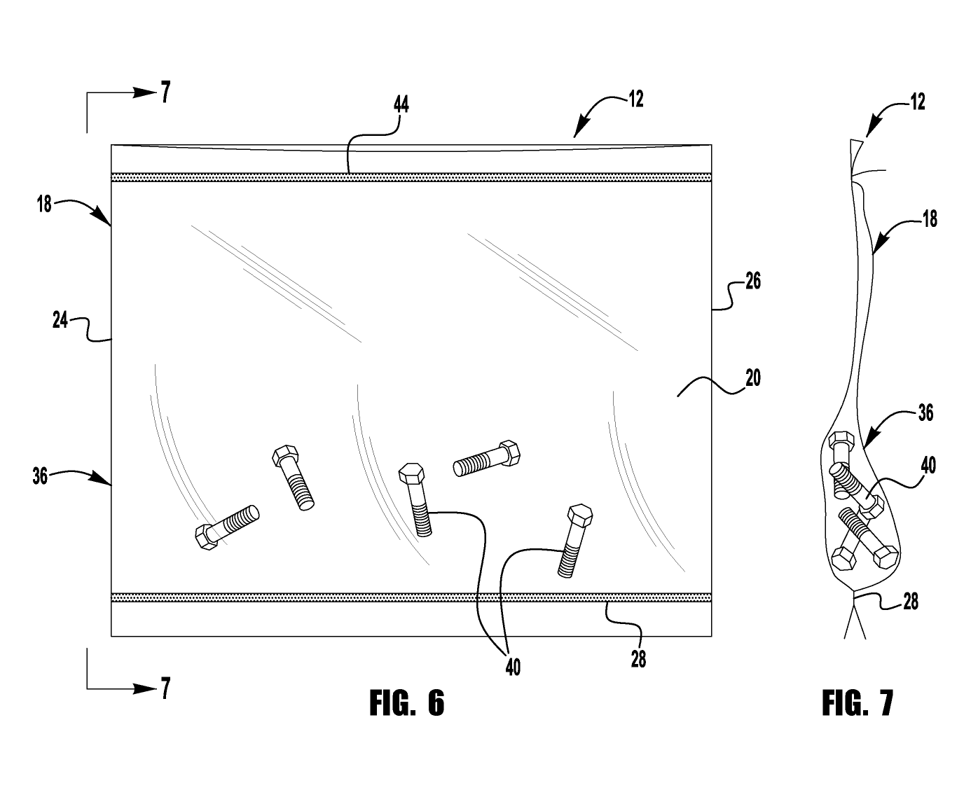

Referring to FIGS. 6 and 7, an exemplary package 12 includes a sealed compartment 36. The package 12 may have any number of compartments. Product 40 is disposed in the compartment 36. The illustrated product 40 is a plurality of bolts. However, the package 12 may contain any product. The compartment is defined by the first and second side edges 24, 26, the preformed seal 28, and a seal 44 that is formed after the product 40 is loaded into the bag. In the example, the seal 44 extends from the first side edge 24 to the second side edge 26 to hermetically seal the compartment 36. In another embodiment, the dividing seal 28 may not extend all the way from the first side edge to the second side edge or may be intermittent to allow communication between the compartment 44 and external air or the compartment 44 and another optional compartment of the package.

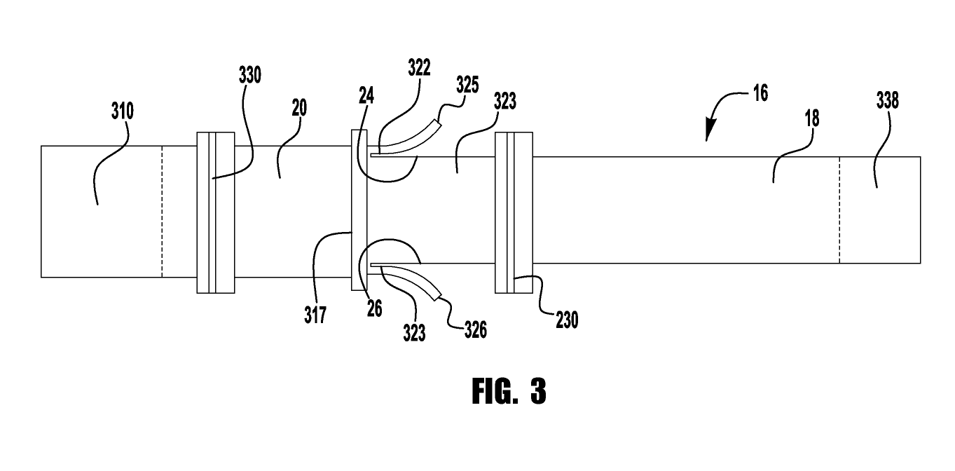

The webs 18 of interconnected bags 16 can be made in a wide variety of different ways. FIGS. 2 and 3 illustrate an exemplary embodiment of a machine and process for making the webs 18 of bags 16 illustrated by FIGS. 1A-1C. Referring to FIGS. 2 and 3 a pair of single ply individual web supplies 310, 312 are provided which are face and back webs 20, 22 respectively. Webs from the supplies 310, 312 are respectively fed along individual paths of travel to perforators 330, 332. The perforator 330 provides the weak line of separation 30 in the web 20. The perforator 332 provides the strong line of separation 32 in the web 22.

The webs 20, 22 are fed from the perforators 330, 332 to a pair of nip rolls 317. The webs 20, 22 are fed from a juncture of the nip rolls 317 along a common path of travel. Hot knives 322, 323 are positioned downstream from the juncture nips 317 to form seals along side edges of the webs and convert the webs into a tube 324. Trim strips 325, 326 formed by the hot knives are removed for collection and recycling. Once formed into a tube the combined webs pass through a sealer 230 which forms transverse seals 28 to become the bottoms of the bags 18 being produced. Thereafter the web, now formed into a container strip of interconnected bags, is collected at a take up 338.

In operation as depicted in FIGS. 2 and 3, coils of single ply plastic are mounted to provide the front and back supplies 310, 312. The materials of the webs may be other than identical so long as they are capable of being sealed together. For example, one web may be pigmented such that it is translucent or opaque while the other web is clear. Typically the plastic will be polyethylene, although other thermal softenable plastics capable of adherence together on application of heat and pressure are sometimes employed.

Webs from the supplies 310, 312 are fed along their respective independent paths of travel through the perforators 330, 332. They are then fed along the path 328 past the hot knives 322,323, the transverse sealer 330, and thence to the take up 338.

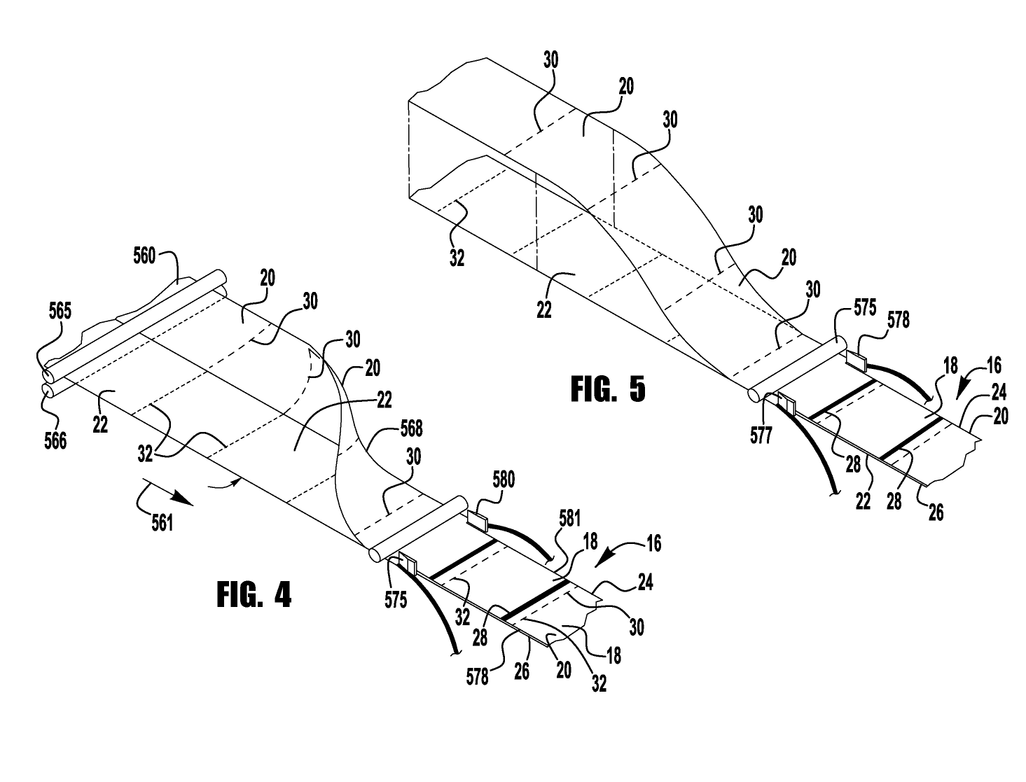

FIG. 4 illustrates another exemplary embodiment of a machine and process for making the webs 18 of bags 16 illustrated by FIGS. 1A-1C. A web 560 is fed along a path of travel indicated by an arrow 561. The weak line of separation 30 and the strong line of separation 32 are concurrently formed in the web 560. In the illustrated embodiment, the weak line of separation 30 and the strong line of separation 32 are formed by coacting cutting and anvil rolls 565,566. As the web 560 proceeds along its path of travel a fold 568 is formed. Through the folding process a face section 20 of the web 560 is superposed over a back section 22. In the illustrated embodiment, the weak line of separation 30 is superposed over the strong line of separation 32.

Transverse seals 28 are formed by a heat sealer shown schematically at 575. Each of the seals shown in FIG. 4, delineates a bottom of one of the chain of bags 16 being formed. A hot knife 577 forms a seal 578 along the web side edge opposite the fold 568 to complete the chain of bags. Optionally a second hot knife 580 may form an optional opposed seal 581.

FIG. 5 illustrates another exemplary embodiment of a machine and process for making the webs 18 of bags 16 illustrated by FIGS. 1A-1C. Referring now to FIG. 5, face and back webs 20, 22, as in the embodiment of FIGS. 2 and 3, are fed along individual paths. The weak lines of separation 30 and the strong lines of separation 32 are pre-formed in the webs 20, 22 in the FIG. 5 embodiment, rather than forming them with the machine that converts the webs 20, 22 to the connected bags. The weak line of separation 30 and the strong line of separation 32 are optionally juxtaposed and the transverse seals 28 and the seal are formed.

While in each embodiments illustrated by FIGS. 2-5, formation of the transverse seals is depicted before the seals, the sequence can obviously be reversed. Similarly, any of the steps or operations illustrated by FIGS. 2-5 can be reordered.

The webs 18 of interconnected bags 16 can be used in a wide variety of different applications. For example, the webs 18 of interconnected bags 16 can be used in a wide variety of different packaging machines. The weaker line of separation 30 allows the openings 130 of the bags 18 to be formed at the time of use, by packaging machine 10, instead of during production of the web 16 of bags 18 before the web 16 is loaded onto the packaging machine. The openings 130 can be formed by breaking or tearing the first ply along the weaker line of separation 30 with the packaging machine, while leaving the strong line of separation 32 intact. This breaking or tearing the first ply along the weaker line of separation 30 to form the opening 130 with the packaging machine, while leaving the strong line of separation 32 intact can be accomplished by a packaging machine in a wide variety of different ways. For example, a suction cup or other adhering device can pull the ply 20 to break the weak line of separation 30. Rollers that advance the web 16 through the machine may be intermittently or continuously rotated at different speeds to pull the ply 20 to break the weak line of separation 30. A predetermined amount of tension that breaks the ply 20 at the weak line of separation 30, but leaves the ply 22 intact at the stronger line of separation 32, may be applied to the web 16. After the bag 18 is loaded and sealed, the strong line of separation 32 can be broken to separate the loaded bag from the next bag to be loaded.

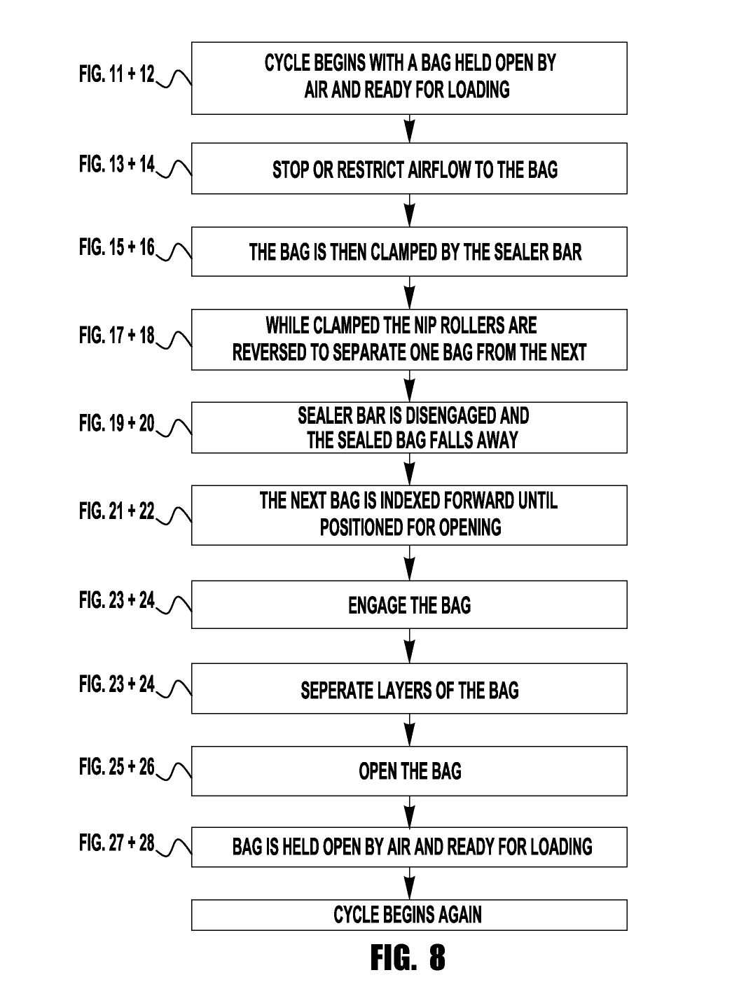

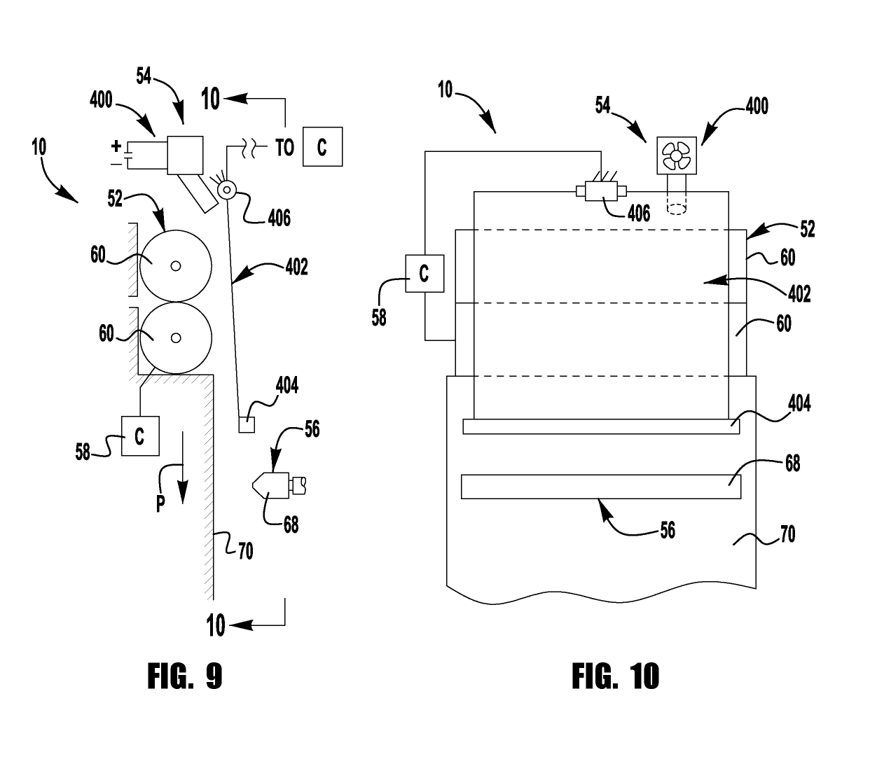

FIG. 8 illustrates a method 8 and FIGS. 9 and 10 illustrate an apparatus 10 for making packages 12 from an elongated web 16 of preformed interconnected bags 18, such as the elongated webs 16 of bags 18 illustrated by FIGS. 1A-1C. In an exemplary embodiment, the web 16 is engaged to move the ply 20 of the web to break the ply 20 at the weak line of separation 30 and form the opening 130.

FIG. 8 is a flow chart 14 that illustrates the method 8 of making packages. Any one or more of the steps of the method illustrated by FIG. 8 may be omitted and/or the order of the steps may be changed without departing from the spirit and the scope of the present invention. That is, steps of the method illustrated by FIG. 8 may be omitted, modified or reduced. For example, any method that breaks the layer 22 at the weak line of separation 30 to form the opening 130 can be used. The flow chart refers to the apparatus 10 shown in FIGS. 9-28 being operated to make packages 12 from an elongated web 16 of preformed interconnected bags 18. However, any apparatus can be used that performs the method shown in FIG. 8. The concepts of the apparatus 10 can be implemented in any of a wide variety of packaging machines. For example, U.S. Pat. No. 3,254,468 to H. Lerner, U.S. Pat. No. 4,928,455 to Gereby et al., U.S. Pat. No. 5,341,625 to Kramer, U.S. Pat. No. 5,394,676 to B. Lerner et al., U.S. Pat. No. 6,543,201 to Cronauer et al., U.S. Pat. No. 6,742,317, U.S. Pat. No. 5,394,676, U.S. Pat. No. 5,371,521, and U.S. Pat. No. 4,899,520 disclose packaging machines that can be modified in accordance with the present invention to make packages from an elongated web of preformed interconnected bags and are all incorporated herein by reference in their entirety.

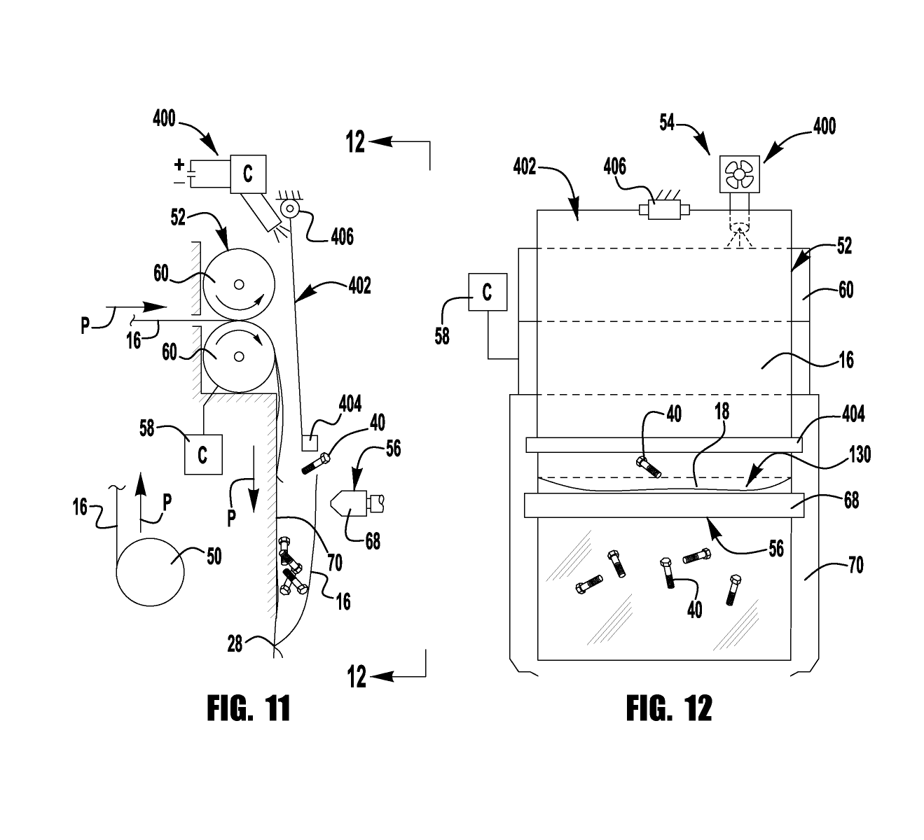

Referring now to FIGS. 9-12, the illustrated apparatus 10 includes a supply 50 (FIG. 11) of the elongated web 16 of preformed interconnected bags 18, an indexing mechanism 52, an opening arrangement 54, a sealing arrangement 56, and a controller 58. The supply 50 comprises the elongated web 16 that is rolled or folded to stage a relatively large amount of the web in a relatively small space. The web 16 is routed from the supply 50 along a path of travel P to the indexing mechanism 52. The indexing mechanism 52 receives the web 16 from the supply and moves the web along the path of travel P. The indexing mechanism 52 may take a wide variety of different forms. For example, any indexing mechanism that can be controlled to index bags of the web to selected positions along the path of travel may be used. In the illustrated example, the indexing mechanism comprises a pair of rollers 60 that form a nip that engages the web 16. The rollers 60 are selectively driven by a motor (not shown) to index bags of the web to selected positions along the path of travel P.

Referring to FIGS. 9 and 10, the opening arrangement 54 is positioned along the path of travel P to open each bag that is to be loaded and sealed. In the illustrated embodiment, the opening arrangement 54 comprises a blower 400 and an engagement device 402. However, the opening arrangement 54 may take a wide variety of different forms.

Referring to FIGS. 9 and 10, the controller 58 is in communication with the indexing arrangement 52, the opening arrangement 54, and the sealing arrangement 56. The controller 58 controls the indexing arrangement 52, the opening arrangement 54, and the sealing arrangement 56 to convert the preformed bags 18 into packages 12. A wide variety of controllers can be used and programmed to control the indexing arrangement 52, the opening arrangement 54, and the sealing arrangement 56 as described herein. For example, the controller and controller algorithms described in U.S. Pat. No. 5,341,625 to Kramer can be modified to control the indexing arrangement 52, the opening arrangement 54, and the sealing arrangement 56 to perform the method 8 of forming packages.

Referring to FIGS. 8, 11 and 12, each bag 18 is blown and/or held open with air or by other means at a position where the bag is loaded with a product 40. The opening of the bags 18 is described in more detail below. When the bag 18 is positioned at the load position and is blown or held open by air, the product 40 is loaded into the bag 18. The product may be loaded manually or automatically. In the illustrated embodiment, the position where the bag 18 is loaded is also the position where bag 18 is sealed. In another embodiment the position where the bag is loaded is different than the position where the bag is sealed. In this embodiment, the controller 58 causes the indexing mechanism 52 to move the bag 18 to the seal position after the bag is loaded with product 40.

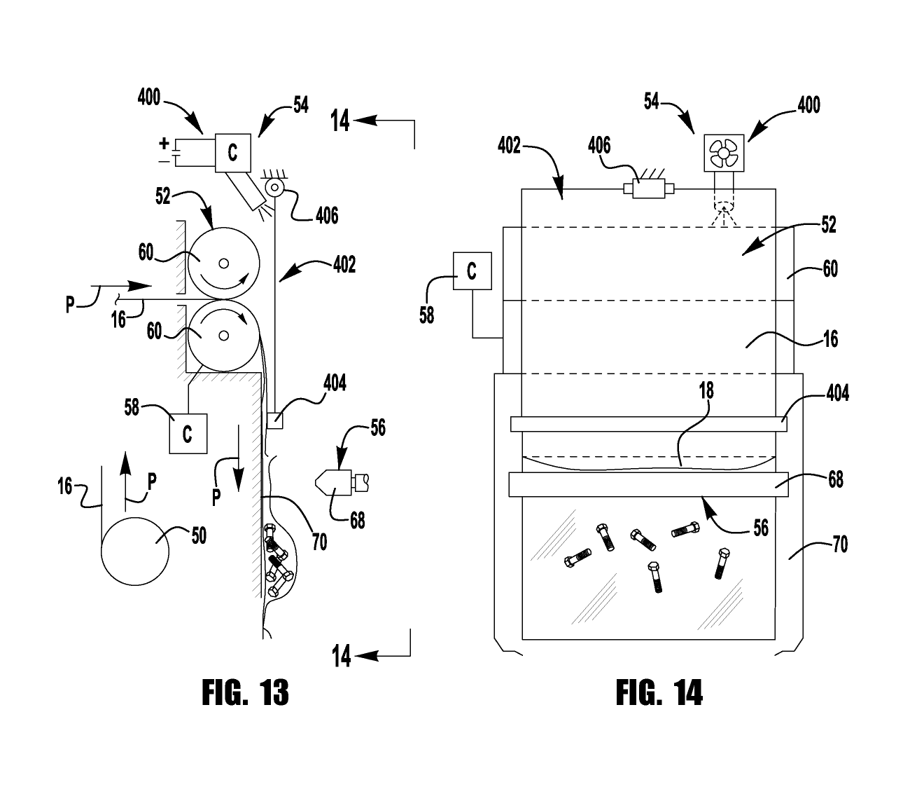

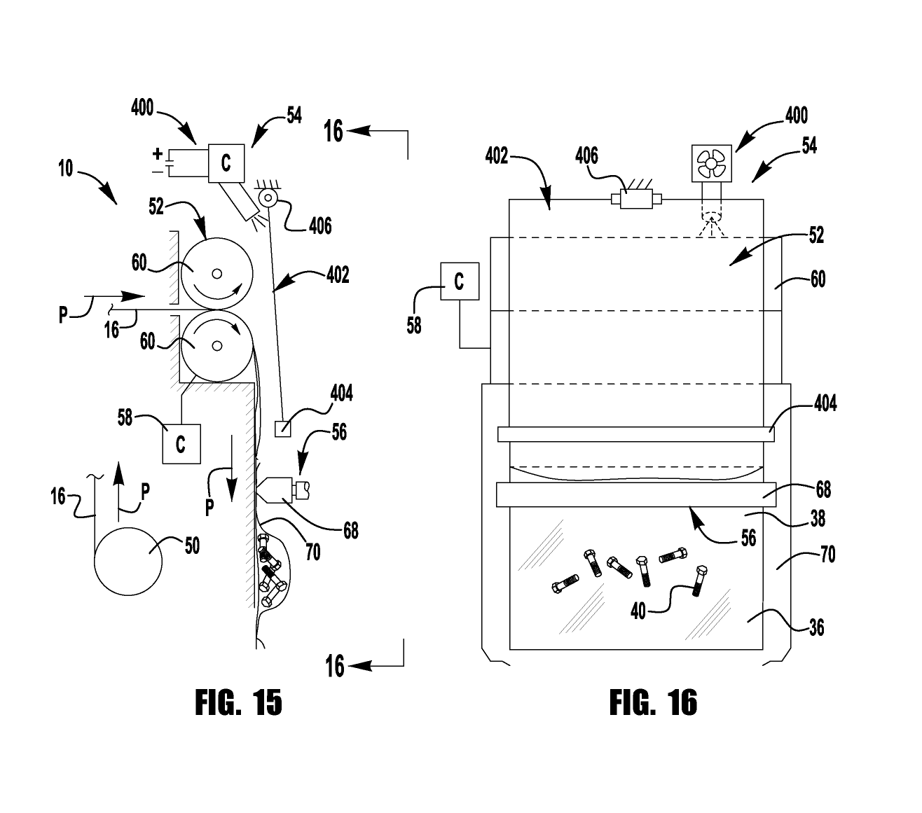

In an exemplary embodiment, once the product is loaded in the bag 18, an operator may provide a signal to the controller 58 that indicates that loading is complete or completion of loading may be automatically detected. The apparatus 10 may be configured to allow the operator to provide the completed loading signal to the controller in a wide variety of different ways. For example, the apparatus may have a control foot pedal (not shown) or the sealing arrangement 56 may have a portion that the operator can push on to indicate that loading is complete and it is time to seal the package. Similarly, the apparatus can be configured to automatically detect completed loading and provide the controller with a signal that indicated this fact. For example, the apparatus may include a counter or may weigh the package to detect completed loading. The signal from the operator or detection of completed loading is communicated to the controller 58, which may cause actuation of the engagement device 402 as shown in FIGS. 13 and 14, actuation of the sealing arrangement 56 as shown in FIGS. 15 and 16, and/or deactivation of the blower as described in more detail below. This stops or restricts airflow to the bag as the bag is sealed.

Referring to FIGS. 13 and 14, once in the seal position, the controller 58 optionally causes a motor or actuator 406 of the engagement device 402 to move an engagement member 404 into engagement with the web 16. The engagement between the engagement member 404 and the web 16 inhibits further air from the blower 400 from moving into the open bag 18, and thus functions as an air restrictor. As a result, the amount of air in the bag 18 diminishes as illustrated by FIG. 13 before the seal is formed.

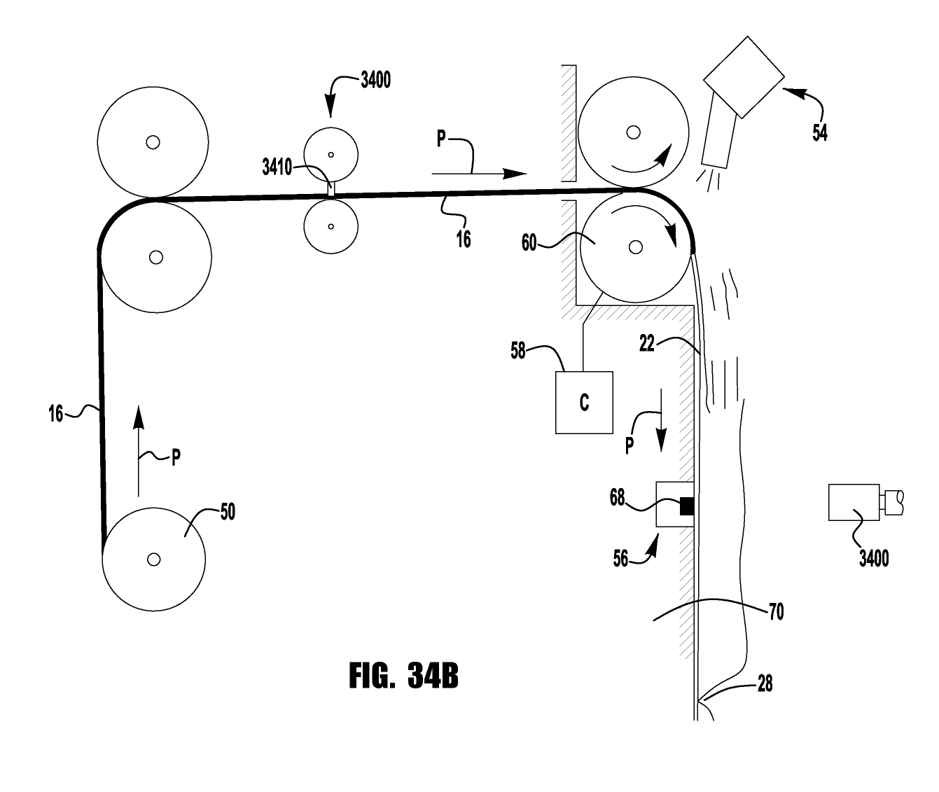

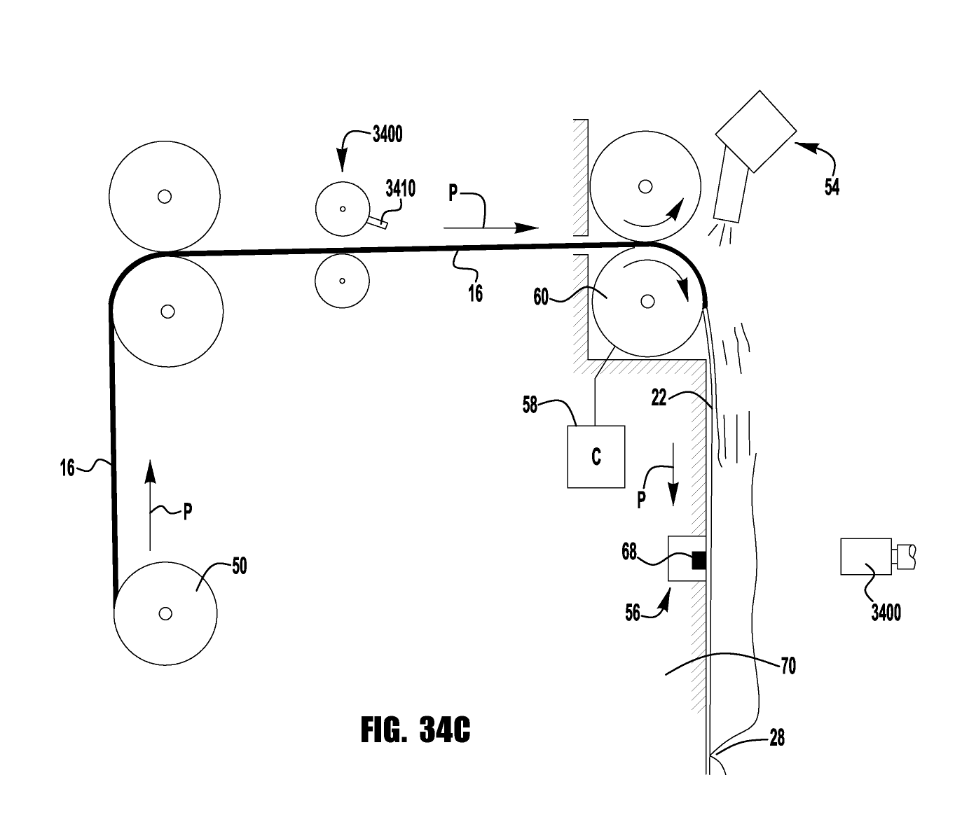

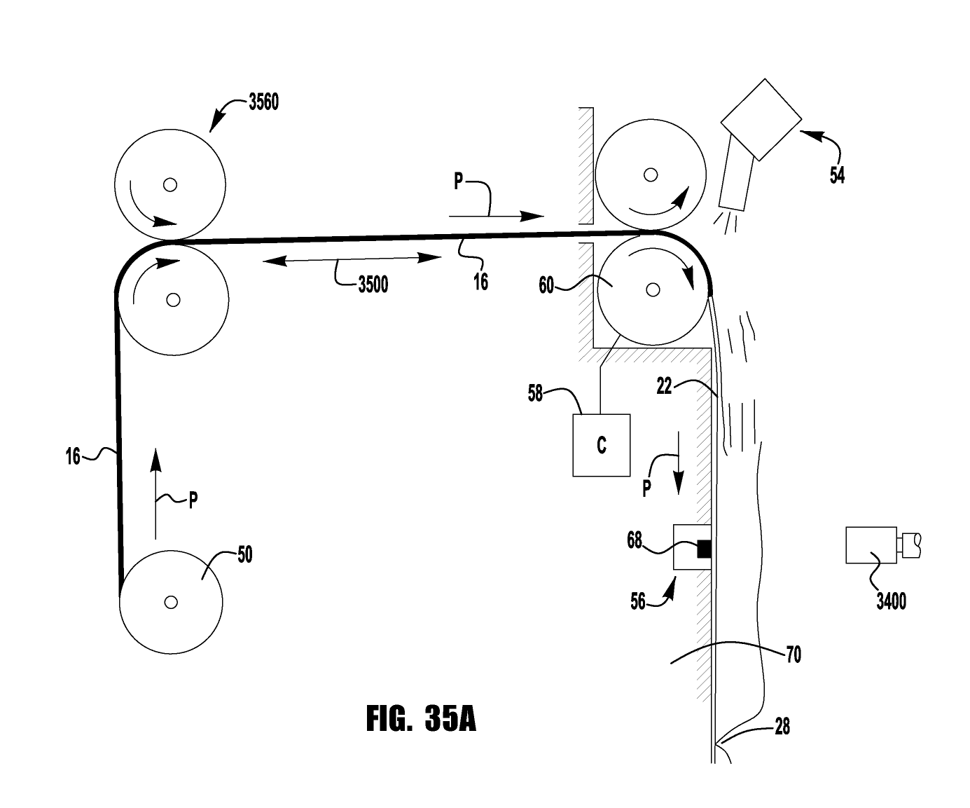

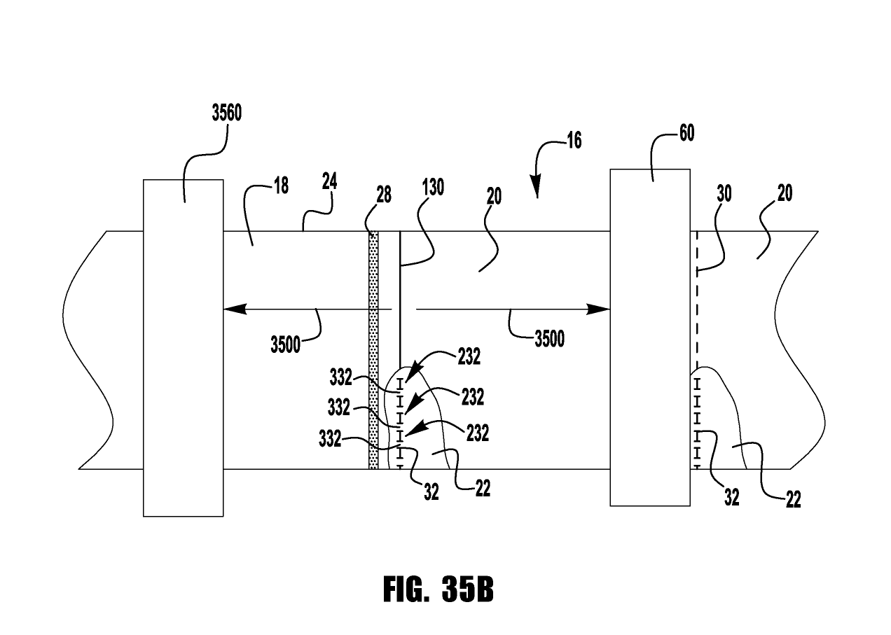

Referring to FIGS. 15 and 16, the sealing arrangement 56 is positioned along the path of travel P to provide the seal 44 (FIG. 5). The sealing arrangement 56 may take a wide variety of different forms. For example, any mechanism that applies heat to the web to seal the first and second webs together to form the seal 44 may be implemented. In the example illustrated by FIGS. 15 and 16, the sealing arrangement 56 comprises a heated bar 68 that is selectively moved into and out of engagement with a base member 70. In the example illustrated by FIGS. 34A-34C and 35A-35C, the sealing arrangement 56 comprises a heated bar 68 mounted to the base 70 and a backing element 3400 that is selectively moved into and out of engagement with the heated bar 68. Any sealing arrangement 56 can be used in any of the embodiments disclosed by this patent application.

When the web is in the seal position, the controller 58 controls the sealing arrangement 56 to clamp the web 16 between the heated bar 68 and the base member 70 (or the backing member 3400 and the heated bar 68). Heat is applied to the web to seal the plies of the web together between the first side edge 24 and the second side edge 26. The first and second plies 20, 22 are sealed together to form the compartment 36. In the exemplary embodiment, the controller 58 causes the motor or actuator 406 of the engagement device 402 to move the engagement member 404 away from the web 16 once the web 16 is clamped by the heated bar.

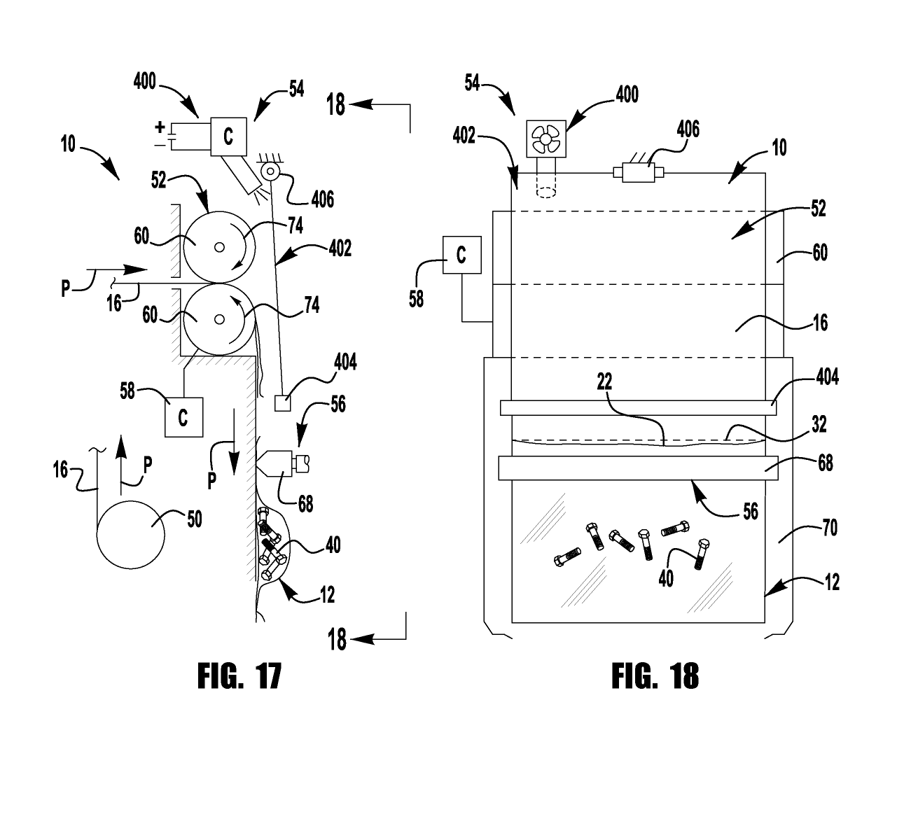

Referring to FIGS. 17 and 18, the formed package 12 is separated from the web 16. The formed package 12 can be separated from the web 16 in a wide variety of different ways. In the example illustrated by FIGS. 17 and 18, the controller 58 controls the indexing mechanism 52 to separate the formed package 12 from the web 16. The second ply 22 is broken along the stronger line of separation 32 to separate the package 12 from the elongated web 16 of interconnected bags 18. The controller 58 controls the indexing arrangement 52 to pull the web 16 away from the bag 18 as indicated by arrows 74 while the bag is clamped by the sealing arrangement 56 in an exemplary embodiment. The bag 18 breaks free of the web 16 along the stronger line of separation 32.

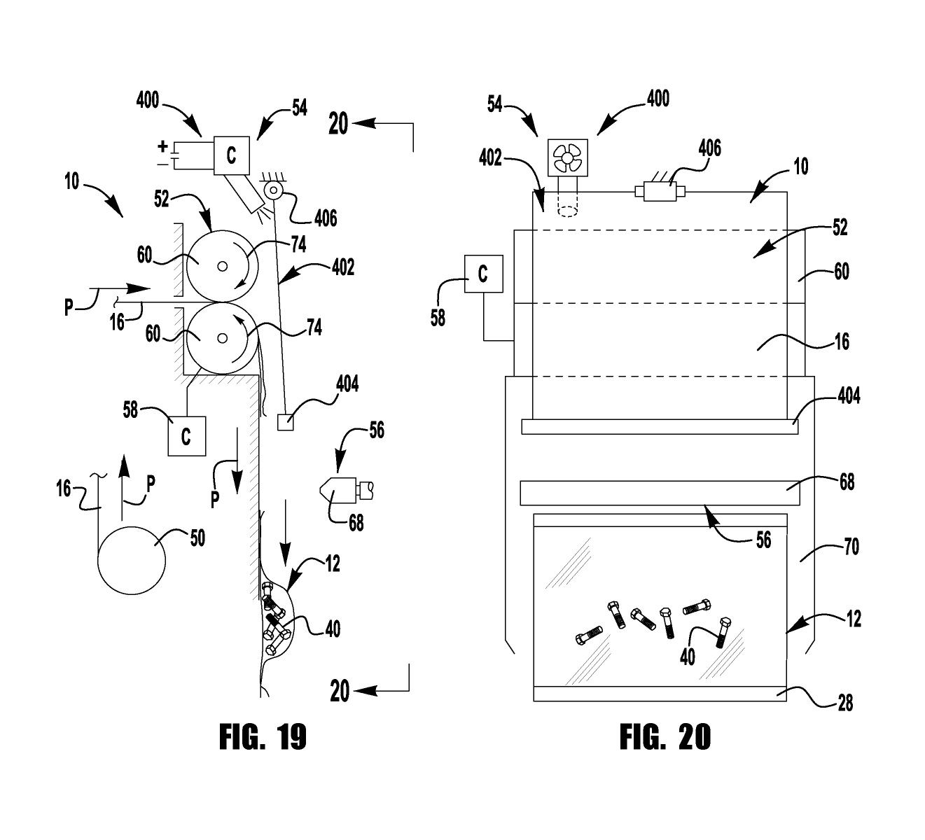

Referring to FIGS. 19 and 20, the formed, separated package 12 is released. The package can be released in a wide variety of different ways. In the illustrated example, the controller 58 controls the sealing arrangement 56 to release the formed package 12.

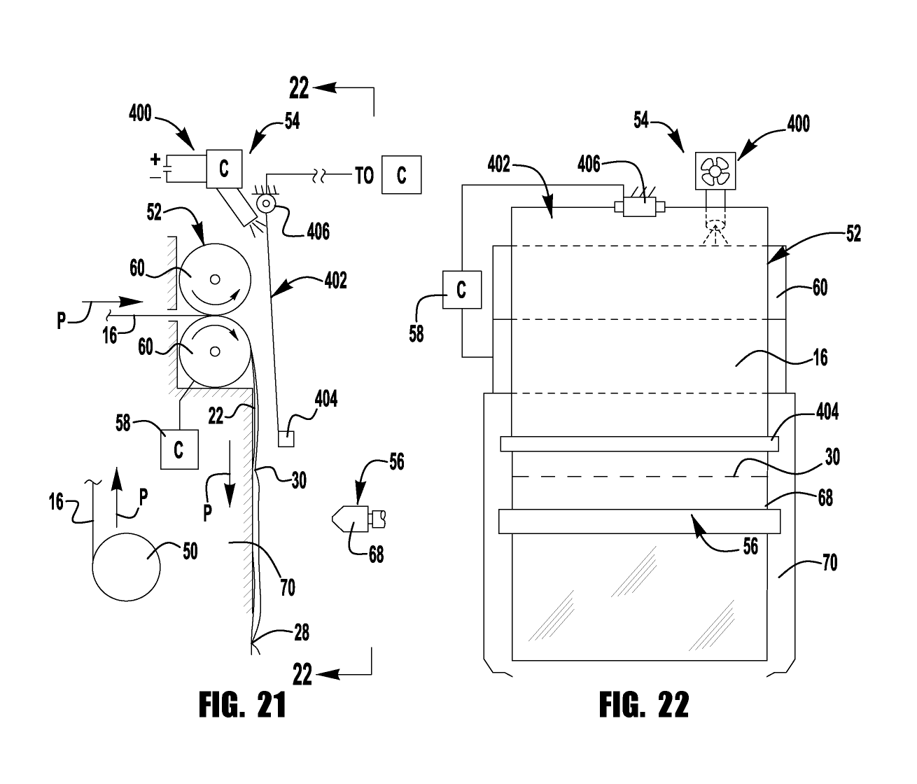

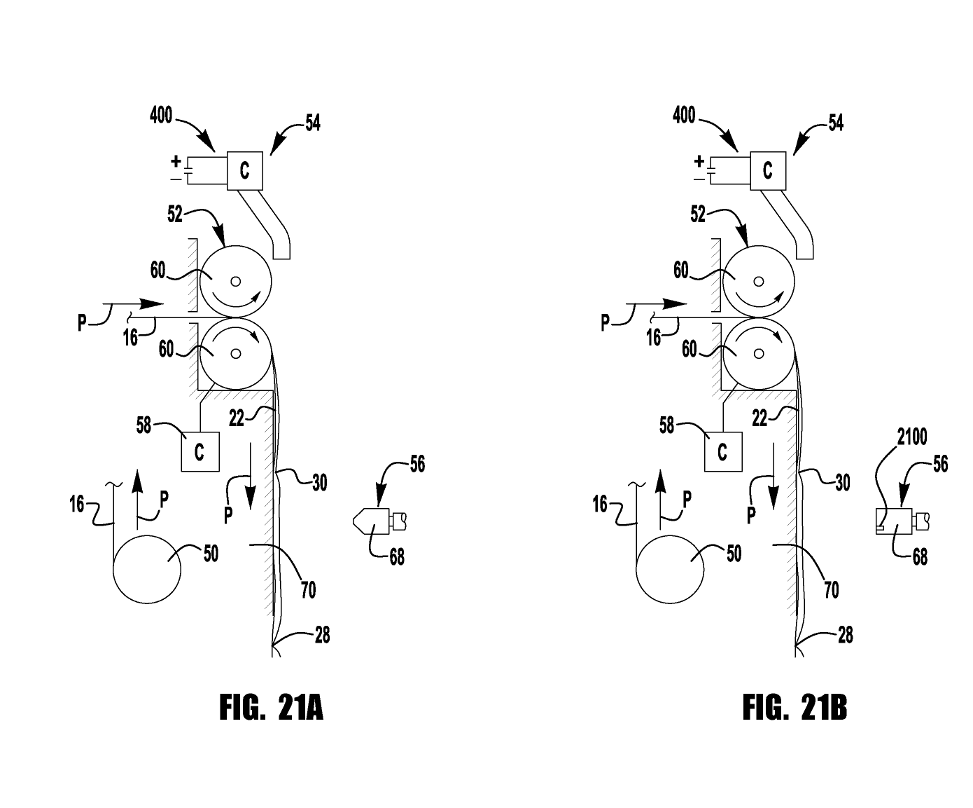

Referring to FIGS. 21 and 22, the next bag 18 is optionally positioned for opening. In other embodiments discussed below, the next bag 18 can be opened as the next bag moves along the path of travel P to the loading position. The next bag 18 can be positioned for opening in a wide variety of different ways and the next bag can be opened in a wide variety of different ways. In the example illustrated by FIGS. 21 and 22, the optional engagement device 402 is used to open the next bag. In the example of FIGS. 21 and 22, the controller 58 controls the indexing mechanism 52 to index the web 16 forward until the weaker line of separation 30 of the next bag 18 is just below the engagement member 404 of the engagement device 402 in the exemplary embodiment. In alternate embodiments, the opening 30 is indexed to other positions. The weaker line of separation 30 can be indexed to any position where engagement of the web by the engagement member 404 and/or movement of the web by the indexing arrangement 52 causes the ply 20 to break at the weaker line of separation 30. For example, the weaker line of separation 30 may be substantially aligned with the engagement member 404 or the opening may be positioned slightly above the engagement member.

In the example illustrated by FIG. 21A, the optional engagement device 402 may be omitted and the sealing arrangement 56 is used to open the next bag. In the example of FIG. 21A, the controller 58 controls the indexing mechanism 52 to index the web 16 forward until the weaker line of separation 30 of the next bag 18 is just below the sealing arrangement 56. In alternate embodiments, the opening 30 is indexed to other positions. The weaker line of separation 30 can be indexed to any position where engagement of the web by sealing arrangement 56 causes the ply 20 to break at the weaker line of separation 30. For example, the weaker line of separation 30 may be substantially aligned with the sealing arrangement 56.

In the example illustrated by FIG. 21B, the optional engagement device 402 may be omitted and a sealing arrangement 56 that includes an opening arrangement 2100 is used to open the next bag. For example, the opening arrangement 2100 may be a suction cup or a vacuum port that is selectively controlled to provided a vacuum. In the example of FIG. 21B, the controller 58 controls the indexing mechanism 52 to index the web 16 forward until the weaker line of separation 30 of the next bag 18 is just above the sealing arrangement 56. In alternate embodiments, the opening 30 is indexed to other positions. The weaker line of separation 30 can be indexed to any position where engagement of the web by opening arrangement 2100 causes the ply 20 to break at the weaker line of separation 30.

Referring to FIGS. 21 and 22, in another exemplary embodiment, the controller 58 may control the indexing mechanism 52 to break the ply 20 at the weaker line of separation 30 to form the opening 130. For example, one of the rollers of the indexing mechanism may be rotated faster or slower than the other roller when the weaker line of separation is at or near the indexing mechanism 52 to break the ply 20 at the weaker line of separation 30 and form the opening 130. The controller 58 then controls the indexing mechanism 52 to index the web 16 forward until the formed opening 130 of the next bag 18 is just below the engagement member 404 of the engagement device 402 in his embodiment.

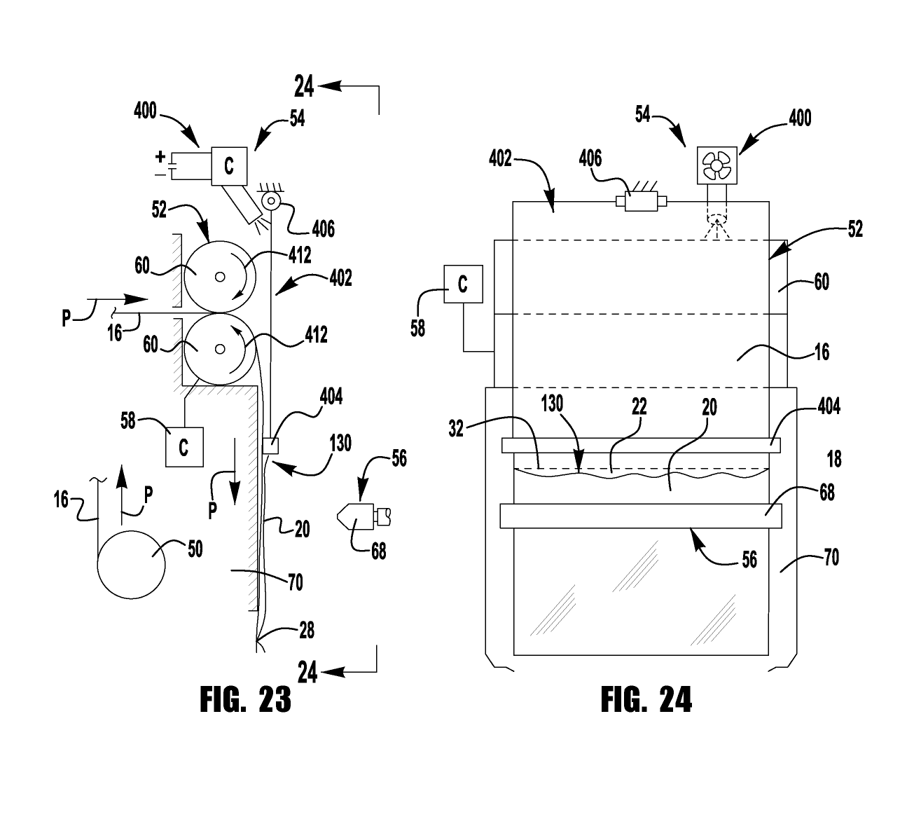

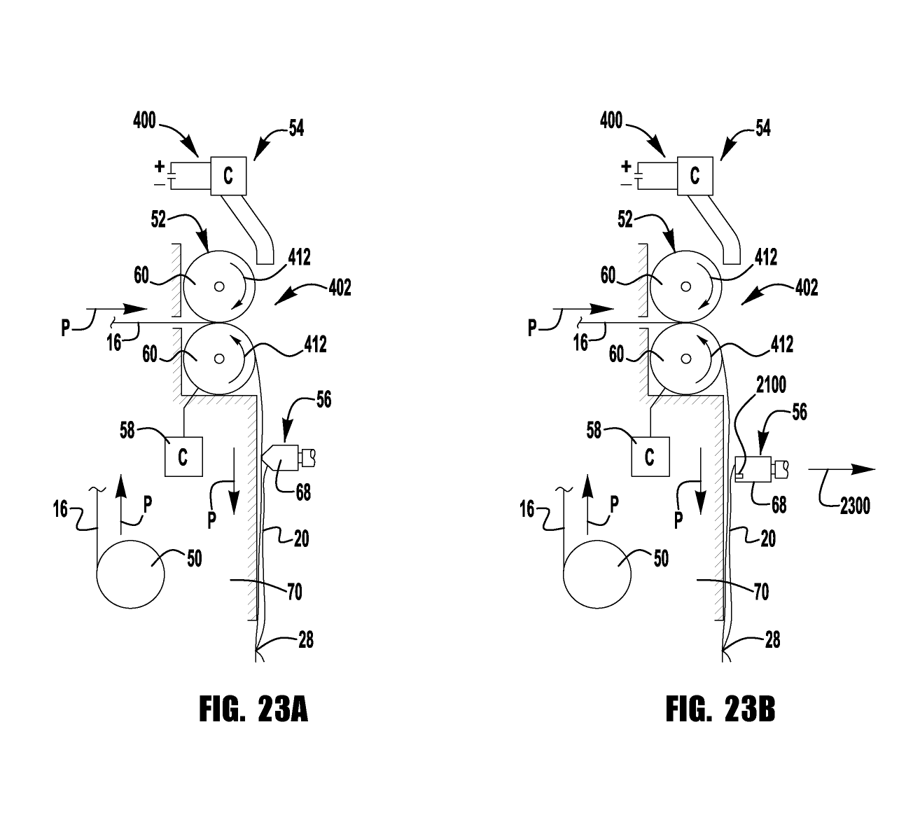

Referring to FIGS. 23 and 24, the controller 58 causes the motor or actuator 406 of the engagement device 402 to move the engagement member 404 into engagement with the web. The engagement of the web 16 with the engagement member 404 alone can be configured to break the ply 20 at the weaker line of separation 30 and form the opening 130. In an exemplary embodiment, the controller 58 causes the indexing mechanism 52 to pull on the web as indicated by arrows 412 while the engagement member 404 is in engagement with the web 16 to break the ply 20 at the weaker line of separation 30 and form the opening 130. In another embodiment, the indexing mechanism moves the web in the opposite direction to break the ply 20 at the weaker line of separation 30 and form the opening 130.

The relative movement of the layers 20, 22 of the web may manifest in a wide variety of different ways. FIG. 24 shows that the layer 20 may wrinkle or pucker at the opening 30 when the web is pulled against the engagement member 404. This wrinkling or puckering creates enough of a space between the two layers at the opening 30 that a small amount of air flow will easily open the bag 18 for filling. The engagement between the engagement member 404 and the web 16 can be at any location on the web that facilitates movement of the two layers 20, 22 at the opening. For example, the engagement can occur a significant distance from weaker line of separation 30 and still break the ply 20 at the weaker line of separation 30 and form the opening 130. In an embodiment, a separate engagement device that is used to break the ply 20 at the weaker line of separation 30 and form the opening 130 is included in addition to an engagement device that is used to reduce the amount of air in the package after the bag is loaded as described above. In another embodiment, the engagement device 402 does not function to reduce the amount of air on the loaded package and the engagement device functions primarily to engage the web to break the ply 20 at the weaker line of separation 30 and form the opening 130.

The engagement device 402 can take a wide variety of different forms. The engagement device 404 may be a pneumatic, hydraulic, or electric actuator with an extendable portion that engages the web to break the ply 20 at the weaker line of separation 30 and form the opening 130 or a driven cam that rotates to engage the web and break the ply 20 at the weaker line of separation 30 and form the opening 130. The engagement device 404 can be any device that moves to engage the web to break the ply 20 at the weaker line of separation 30 and form the opening 130.

Referring to FIG. 23A where the sealing arrangement 56 is used to open the next bag 18, the controller 58 moves the sealing arrangement 56 into engagement with the web, with less force than when the sealing arrangement is sealing the web. The engagement of the web 16 with the sealing arrangement alone can be configured to break the ply 20 at the weaker line of separation 30 and form the opening 130. In an exemplary embodiment, the controller 58 causes the indexing mechanism 52 to pull on the web as indicated by arrows 412 while the sealing arrangement 56 is in engagement with the web 16 to break the ply 20 at the weaker line of separation 30 and form the opening 130. In another embodiment, the indexing mechanism moves the web in the opposite direction to break the ply 20 at the weaker line of separation 30 and form the opening 130.

The relative movement of the layers 20, 22 of the web may manifest in a wide variety of different ways. The layer 20 may wrinkle or pucker at the opening 30 when the web is pulled against the sealing device 56. This wrinkling or puckering creates enough of a space between the two layers at the opening 30 that a small amount of air flow will easily open the bag 18 for filling. The engagement between the sealing device 56 and the web 16 can be at any location on the web that facilitates movement of the two layers 20, 22 at the opening. For example, the engagement can occur a significant distance from weaker line of separation 30 and still break the ply 20 at the weaker line of separation 30 and form the opening 130.

Referring to FIG. 23B where the opening arrangement 2100 of the sealing arrangement is used to open the next bag 18, the controller 58 first moves the opening arrangement 2100 into engagement with the web or proximate to the web 2100. For example, when the opening arrangement 2100 is attached to the sealing device 56, the controller moves the sealing device 56 to move the opening arrangement 2100 into engagement with the web or proximate to the web 2100. The opening arrangement 2100 then couples to the web. For example, when the opening arrangement is a suction cup, the suction cup may press against the web. When the opening arrangement 2100 is a vacuum port, the controller 58 may apply a vacuum at the port to suck the web against opening arrangement. The controller 58 then moves the opening arrangement 2100 away 2300 from the base 70 to break the ply 20 at the weaker line of separation 30 and form the opening 130. For example, when the opening arrangement 2100 is attached to the sealing device 56, the controller moves the sealing device 56 to form the opening 130. The opening arrangement 2100 then decouples from the web. For example, when the opening arrangement is a suction cup, the pulling of the suction cup away from the web may cause the suction cup to release the web. When the opening arrangement 2100 is a vacuum port, the controller 58 may stop applying a vacuum at the port to release the web. In the exemplary embodiment illustrated by FIG. 23B, the controller 58 does not need to cause the indexing mechanism 52 to pull on the web as indicated by arrows 412, since movement of the opening arrangement 2100 breaks the ply 20 at the weaker line of separation 30 and forms the opening 130.

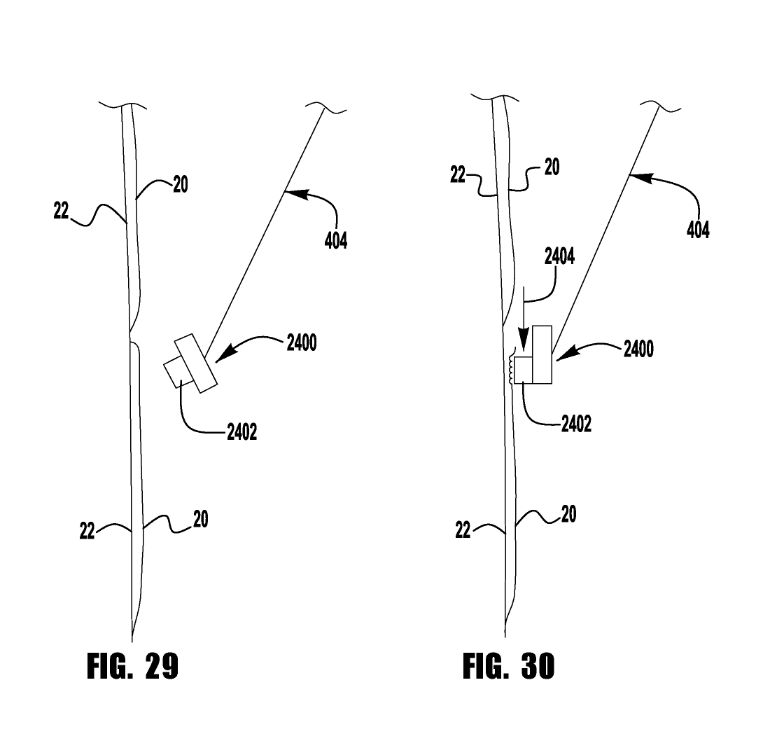

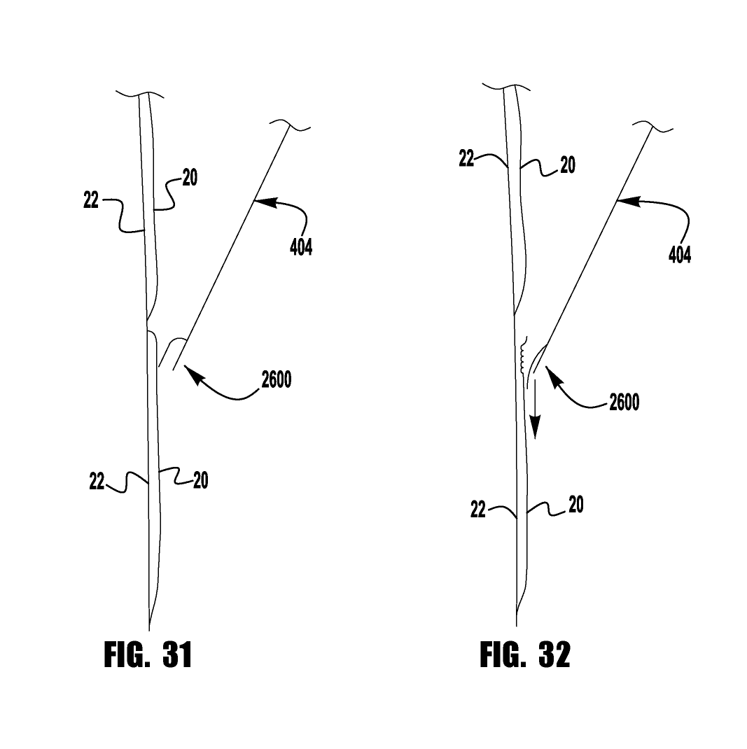

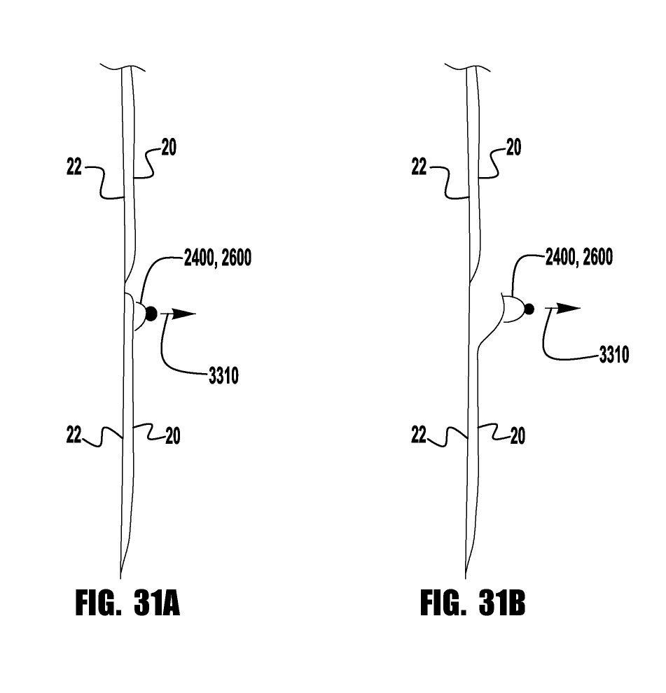

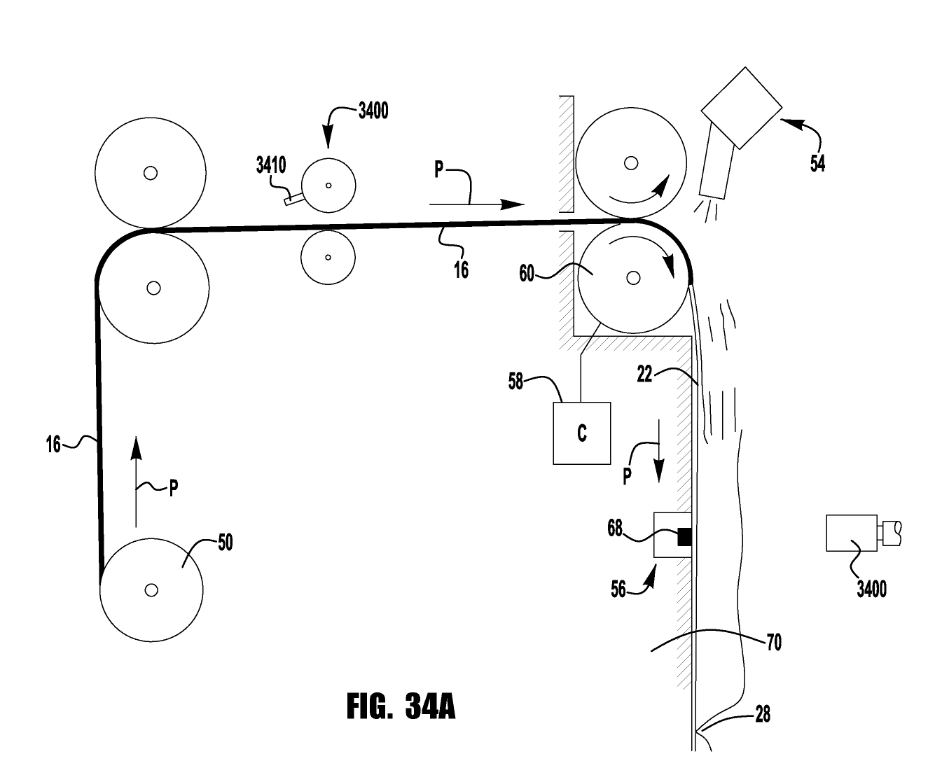

Referring to FIGS. 29-32, 33A, 33B, 34A, 34B, 34C, 35A, 35B in some embodiments the indexing arrangement is not reversed to pre-open the bags. For example, the optional engagement device may include an optional device 2400 (FIGS. 29 and 39) or member 2600 (FIGS. 31, 32, 33A, and 33B) that helps the engagement member 404 break the ply 20 at the weaker line of separation 30 and form the opening 130. Further examples include an optional engagement device 3400 that may be provided along the path of travel P upstream of the rollers 60 (FIGS. 34A, 34B, and 34C) and/or an optional set of rollers 3560 that may cooperate with the rollers 60 (FIGS. 35A and 35B) to break the ply 20 at the weaker line of separation 30 and form the opening 130.

Referring to FIGS. 29 and 30, the optional device 2400 may be a powered device with a portion 2402 that forces the front layer 20 of the web upward or downward when the engagement member 404 engages the web. In the example illustrated by FIGS. 29 and 30, the portion 2402 moves downward as indicated by arrow 2404 to break the ply 20 at the weaker line of separation 30 and form the opening 130. The optional member 2600 may be a spring member or spring biased member that forces the front layer of the web upward or downward when the engagement member 404 engages the web. In the example illustrated by FIGS. 31 and 32, the optional member 2600 comprises a spring arm or leaf spring that is compressed and extends to move the front layer of the web downward as indicated by arrow 2604 break the ply 20 at the weaker line of separation 30 and form the opening 130.

Referring to FIGS. 33A and 33B, in another exemplary embodiment, the optional device 2400 or optional member 2600 is simply a device that frictionally engages the ply and pulls 3310 the ply 20 away from the ply 22 to break the ply 20 at the weaker line of separation 30 and form the opening 130. For example the optional member 2600 may be a suction cup, that may optionally be connected to a source of vacuum, may be configured to statically cling to the ply 20, or may be abrasive, such as sandpaper.

Referring to FIGS. 34A, 34B, and 34C, in one exemplary embodiment, an optional engagement device 3400 is provided along the path of travel P upstream of the rollers 60 (FIGS. 34A, 34B, and 34C) to break the ply 20 at the weaker line of separation 30 and form the opening 130. The engagement device 3400 can take a wide variety of different forms. In the illustrated embodiment, the engagement device 3400 includes a rotating projection 3410. The rotating projection 3410 is driven into contact with the ply 20 (FIG. 34B) to zing or break the weaker line of separation 30 and leave the stronger line of separation in tact. The rotation of the rotating projection 3410 can be controlled by the controller to engage each bag only once, proximate to the weaker line of separation 30 and form the opening 130 or the rotating projection can simply be rotated at a constant speed. The rotation may correspond to the direction the web 16 moves as shown or may be opposite of the direction of movement of the web 16. The engagement device 3400 may be positioned at any point along the path of travel P. In the illustrated embodiment, the engagement device 3400 is positioned between an optional set of rollers 3560 and rollers 60. The engagement device 3400 could also be positioned to engage the web 16 between the supply 50 and the rollers 3560 or the engagement device 3400 could be positioned to engage the web 16, break the ply 20 at the weaker line of separation 30, and form the opening 130, while the web 16 is still on the illustrated supply roll 50.

FIGS. 35A and 35B illustrate an exemplary embodiment where the web 16 is stretched as indicated by double arrow 3500 to break the ply 20 at the weaker line of separation 30, while leaving the ply 18 in tact along the stronger line of separation 32. The web may be stretched to break the ply 20 at the weaker line of separation 30, while leaving the ply 18 in tact along the stronger line of separation 32 in a wide variety of different ways.

In one exemplary embodiment, the web 16 is configured such an amount or length of stretching of the ply 20 at the weaker line of separation 30 that causes the ply 20 to break along the weaker line of separation 30 is less than an amount or length of stretching of the ply 18 at the stronger line of separation 32 that causes the ply 18 to break along the stronger line of separation 32. In one exemplary embodiment, stretching the ply 20 at the weaker line of separation 30 1/16th of an inch causes the ply 20 to break along the weaker line of separation 30, while the ply 18 at the stronger line of separation 30 remains intact until the ply 18 is stretched at least ⅛th of an inch at the stronger line of separation 32.

In the embodiment illustrated by FIGS. 35A and 35B, a set of rollers 3560 cooperates with the rollers 60 to break the ply 20 at the weaker line of separation 30 and form the opening 130. The set of rollers 3560 can accomplish this in a wide variety of different ways. Any manner of using the rollers 3560 to stretch the web to break the ply 20 at the weaker line of separation 30, while leaving the ply 18 in tact along the stronger line of separation 32 can be employed.

In one exemplary embodiment, the rollers 3560 can be configured to apply a predetermined or controllable drag force on the web 16 between the rollers 3560 and the rollers 60. For example, stretching 3500 can be accomplished by placing a continuous drag force on one or more of the rollers 3560 and/or selectively braking one or more of the rollers 3560 while the weaker line of separation 30 is between the rollers 3560 and the rollers of the indexing mechanism 52. The controller may control both the time and duration the rollers 3560 are braked to stretch the web to break the ply 20 at the weaker line of separation 30, while leaving the ply 18 in tact along the stronger line of separation 32.

As another example, the rollers 3560 can be driven rollers and the controller 58 may control the indexing mechanism 52 and/or the rollers 3560 to break the ply 20 at the weaker line of separation 30 to form the opening 130. For example, the rollers 3560 may be rotated relatively slower than the rollers of the indexing mechanism 52 when the weaker line of separation 30 is between the rollers 3560 and the rollers of the indexing mechanism 52 to stretch 3500 the web and form the opening 130. This stretching can be accomplished by selectively rotating the rollers of the indexing mechanism 52 faster than the rollers 3560 or selectively rotating the rollers 3560 slower than the rollers of the indexing mechanism.

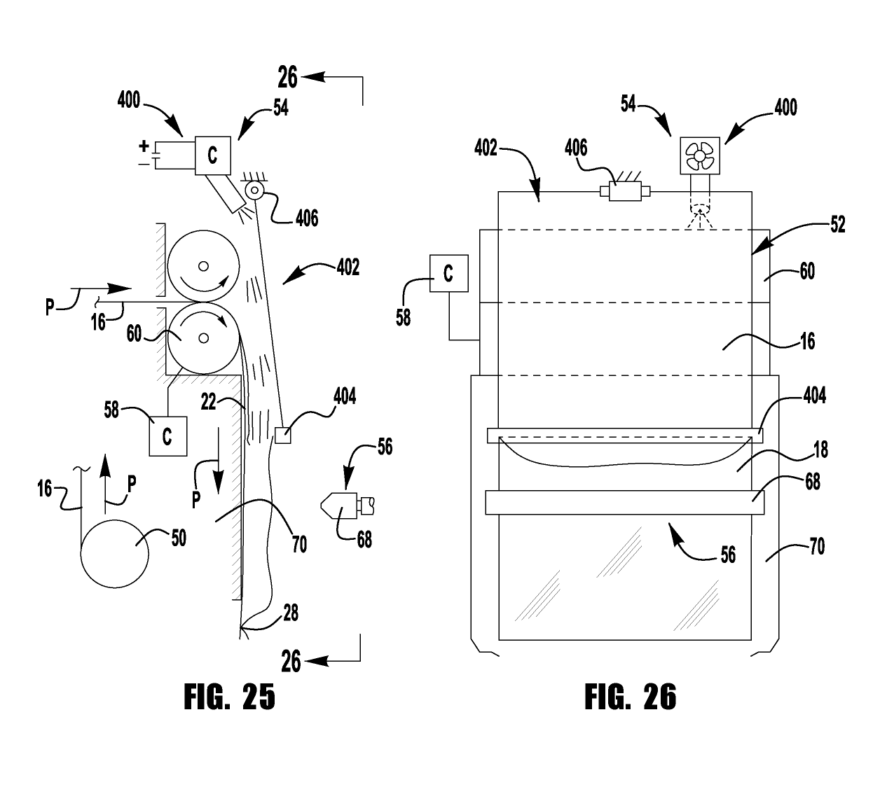

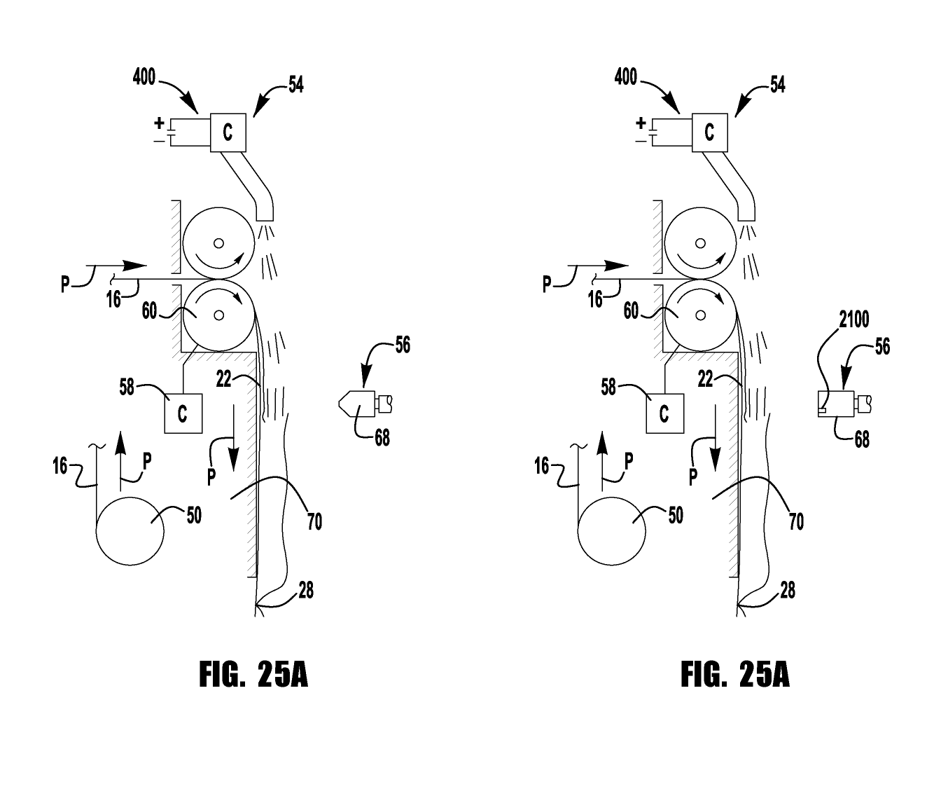

Referring to FIGS. 25 and 26, the controller causes the motor or actuator 406 of the optional engagement device 402 to move the engagement member 404 out of engagement with the web. Air from the blower 400 is forced between the plies 20, 22 at the opening 130 of the bag. The air is forced between the plies through the opening 130 to inflate the bag 18 for depositing product 40 therein.

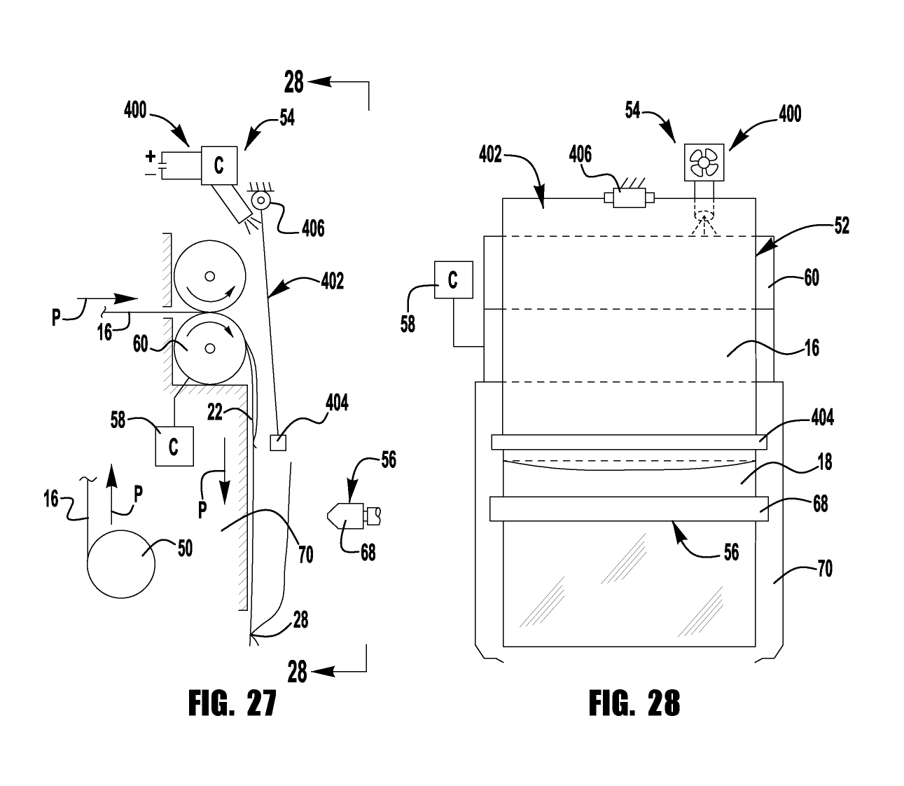

Referring to FIGS. 27 and 28, the controller 58 indexes the web 16, with the open bag 18 to the load position (if the load position does not coincide with the opening position). The bag is blown or held open by the air and the cycle begins again. The controller may repeat the method as required to produce as many packages are needed from the web.

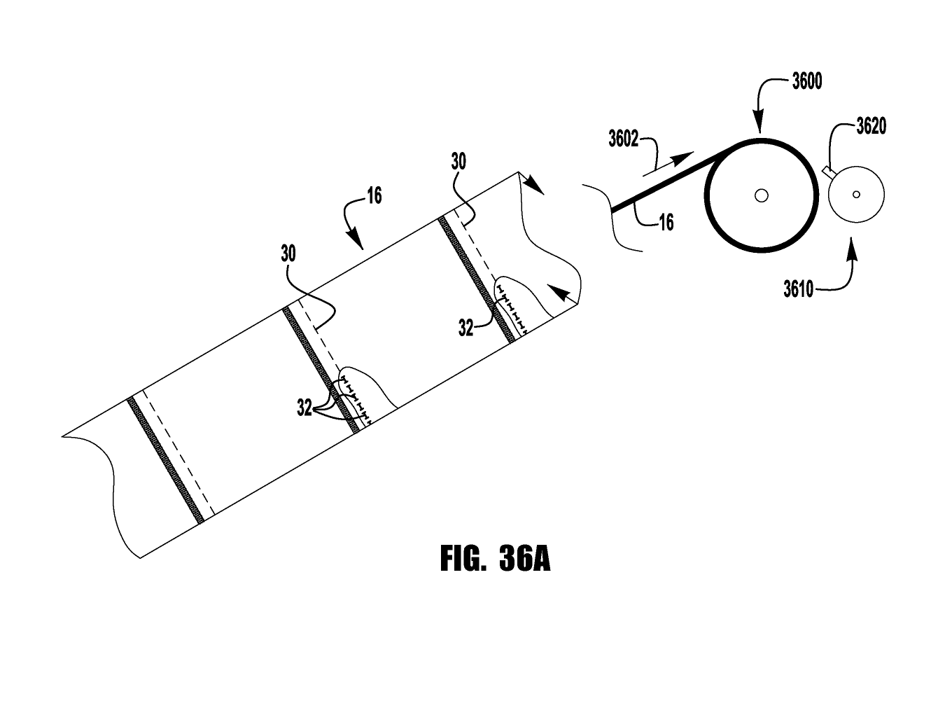

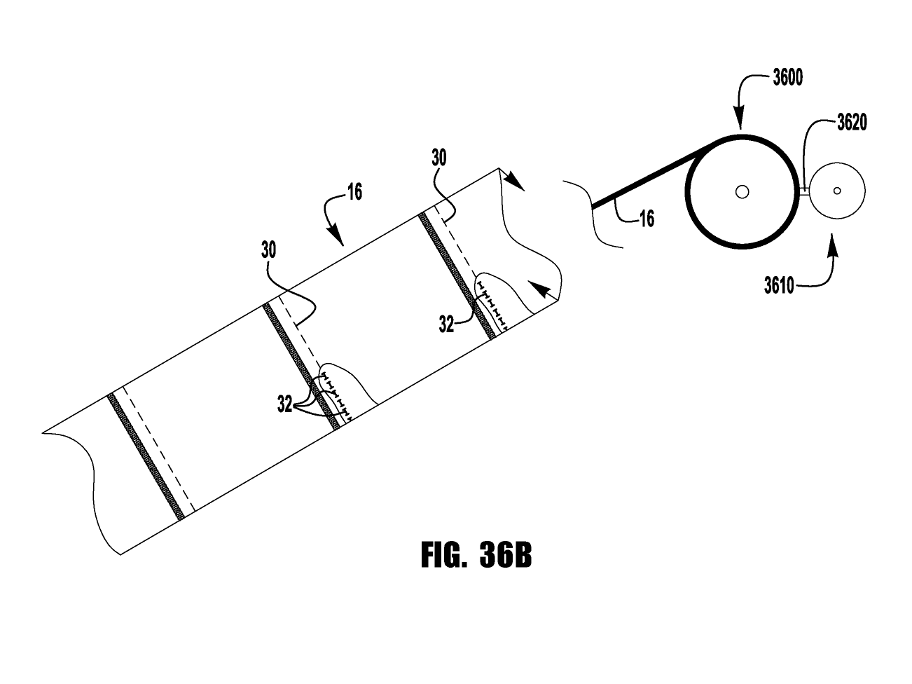

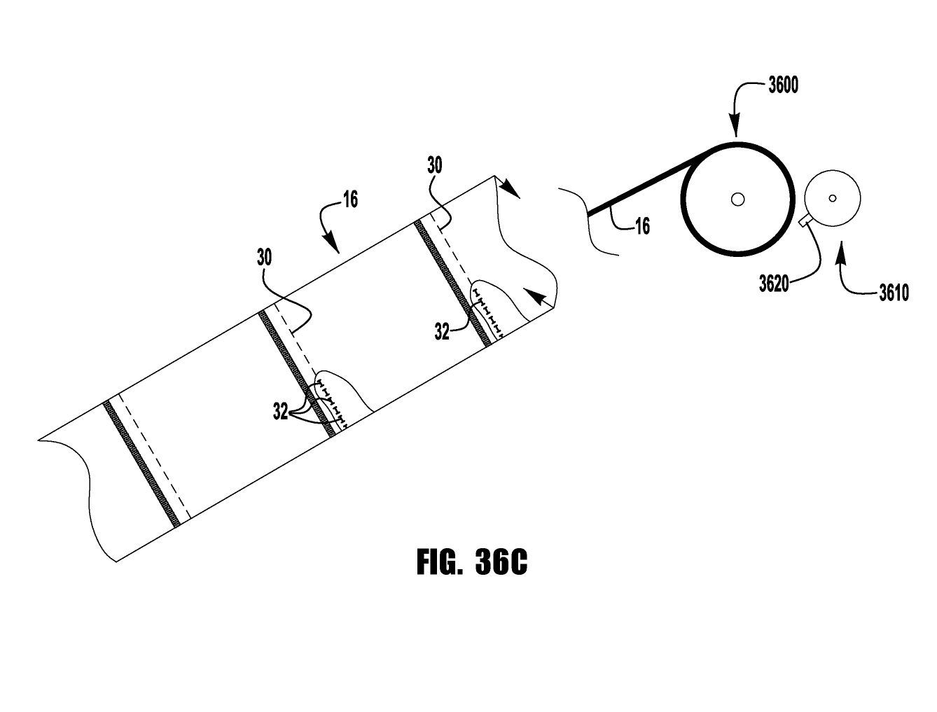

FIGS. 36A-36C illustrate an exemplary embodiment where the opening 130 is formed during the manufacturing and packaging of the web 16, before the web 16 is provided to the packaging machine 10. In the example illustrated by FIGS. 35A-35C a web 16 as described herein is formed (shown as a partially sectioned plan view in FIGS. 36A and 36B to show the formed seals and lines of weakness), moved in direction 3602 and rolled onto a roll 3600 (shown as a side view in FIGS. 36A and 36B). In the example illustrated by FIGS. 36A-36C, the ply 20 is broken at the weaker line of separation 30, while the web 16 is on the roll 3600 to form the opening 130, and while leaving the ply 18 in tact along the stronger line of separation 32. This forming of the opening 130 while the web 16 is on the roll 3600 prevents air from entering the bags, since the bags are already wound tightly on the roll. Still referring to FIGS. 36A-36C, the forming of the opening 130 while on the roll 3600 can be accomplished in a wide variety of different ways. Any manner of breaking the ply 20 at the weaker line of separation 30, while the web 16 is on the roll 3600 to form the opening 130, and while leaving the ply 18 in tact along the stronger line of separation 32 can be employed. In the example illustrated by FIGS. 36A-36C, an engagement device 3610 is provided near the roll 3600 to break the ply 20 at the weaker line of separation 30 and form the opening 130. The engagement device 3610 can take a wide variety of different forms. In the illustrated embodiment, the engagement device 3610 includes a rotating projection 3620. The rotating projection 3620 is driven into contact with the ply 20 (FIG. 36B) to zing or break the weaker line of separation 30 and leave the stronger line of separation intact, while the web 16 is on the roll 3600. The rotation of the rotating projection 3620 can be controlled by a production controller to engage each bag only once, proximate to the weaker line of separation 30 and form the opening 130. The rotation may correspond to the direction the web 16 moves as shown or may be opposite of the direction of movement of the web 16.

As described herein, when one or more components are described as being connected, joined, affixed, coupled, attached, or otherwise interconnected, such interconnection may be direct as between the components or may be in direct such as through the use of one or more intermediary components. Also as described herein, reference to a “member,” “component,” or “portion” shall not be limited to a single structural member, component, or element but can include an assembly of components, members or elements. Also as described herein, the terms “substantially” and “about” are defined as at least close to (and includes) a given value or state (preferably within 10% of, more preferably within 1% of, and most preferably within 0.1% of)

It should be understood that the embodiments discussed above are representative of aspects of the invention and are provided as examples and not an exhaustive description of implementations of an aspect of the invention. While various inventive aspects, concepts and features of the disclosures may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts and features of the disclosures—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present application even if such embodiments are not expressly disclosed herein. Additionally, even though some features, concepts or aspects of the disclosures may be described herein as being a preferred arrangement or method, such description is not intended to suggest that such feature is required or necessary unless expressly so stated. Still further, exemplary or representative values and ranges may be included to assist in understanding the present application, however, such values and ranges are not to be construed in a limiting sense and are intended to be critical values or ranges only if so expressly stated. Moreover, while various aspects, features and concepts may be expressly identified herein as being inventive or forming part of an disclosure, such identification is not intended to be exclusive, but rather there may be inventive aspects, concepts and features that are fully described herein without being expressly identified as such or as part of a specific disclosure, the disclosures instead being set forth in the appended claims. Descriptions of exemplary methods or processes are not limited to inclusion of all steps as being required in all cases, nor is the order that the steps are presented to be construed as required or necessary unless expressly so stated. The words used in the claims have their full ordinary meanings and are not limited in any way by the description of the embodiments in the specification.

What is claimed is:

1. A web of preformed bags, comprising:
first and second layers;
first and second side edges that hermetically join the first and second layers;
a plurality of transverse seals extending between the first and second side edges;
a plurality of first lines of weakness in the first layer; and
a plurality of second lines of weakness in the second layer;
wherein the first lines of weakness are weaker than the second lines of weakness; and
wherein the preformed bags are defined by the first and second side edges, the first and second lines of weakness, and the transverse seals.

2. The web of preformed bags of claim 1, wherein the first line of weakness is superposed over the second line of weakness.

3. The web of preformed bags of claim 1, wherein a first breaking force required to break the first line of weakness is substantially less than a second breaking force required to break a second line of weakness.

4. The web of preformed bags of claim 2, wherein the first and second breaking forces are tensile forces applied orthogonally to the first and second lines of weakness.

5. The web of preformed bags of claim 1, wherein the first and second lines of weakness are formed of perforations.

6. The web of preformed bags of claim 5, wherein the perforations of the first line of weakness are longer than the perforations of the second line of weakness.

7. The web of preformed bags of claim 1, wherein the first line of weakness comprises elongated cuts separated by ticks of plastic.

8. The web of preformed bags of claim 1, wherein the first ply is formed of a first material, the second ply is formed of a second material, and the first material is weaker than the second material.

9. A method of forming packages from a web of preformed bags, comprising:
providing a web of preformed bags, wherein the web of preformed bags includes first and second elongated layers, first and second side edges that hermetically join the first and second layers, a plurality of transverse seals extending between the first and second side edges, a plurality of first lines of weakness in the first layer, and a plurality of second lines of weakness in the second layer, wherein the first lines of weakness are weaker than the second lines of weakness;
breaking the first line of weakness without completely breaking the second line of weakness to open a bag of the preformed web of bags.

10. The method of forming packages from a web of preformed bags of claim 9, wherein breaking the first line of weakness comprises reverse indexing of an indexing mechanism.

11. The method of forming packages from a web of preformed bags of claim 9, wherein breaking first line of weakness comprises a first indexing roller in contact with the first layer and a second indexing roller in contact with the second layer, wherein the first indexing roller is rotated faster than the second indexing roller.

12. The method of forming packages from a web of preformed bags of claim 9, wherein breaking the first line of weakness comprises an engagement member.

13. The method of forming packages from a web of preformed bags of claim 12, wherein the engagement member comprises a powered device having a portion that moves the first layer relative to the second layer to break the first line of weakness.

14. The method of forming packages from a web of preformed bags of claim 12, wherein the engagement member comprises an extendable portion.

15. The method of forming packages from a web of preformed bags of claim 12, wherein the engagement member comprises a spring member.

16. The method of forming packages from a web of preformed bags of claim 12, wherein breaking the first line of weakness further comprises reverse indexing of an indexing mechanism.

17. The method of forming packages from a web of preformed bags of claim 9, further comprising:
inserting a product into the open bag;
sealing the bag proximate the first and second lines of weakness; and
breaking the second line of weakness to separate the bag from the web.

18. The method of forming packages from a web of preformed bags of claim 17, wherein the bag is held open by air.

19. The method of forming packages from a web of preformed bags of claim 17, wherein breaking of the second line of weakness comprises reverse indexing of an indexing mechanism.

20. The method of forming packages from a web of preformed bags of claim 9, wherein the web of preformed bags is provided on a supply roll.
